(19) United States
(12) Patent Application Publication
(10) Pub. No.: US 2005/0141681 A1
(43) Pub. Date: Jun. 30, 2005

(54) Mobile arithmetic unit and extension device for industrial machine control

(76) Inventor: Dieter Graiger, Plesching (AT)

Correspondence Address: WILLIAM COLLARD;COLLARD & ROE, P.C., 1077 NORTHERN BOULEVARD, ROSLYN, NY, 11576, US

(21) Appl. No.: 10/510,584

(22) PCT Filed: Apr. 1, 2003
(86) PCT No.: PCT/AT03/00093

(30) Foreign Application Priority Data
Apr. 12, 2002 (AT) A 565/2002

(51) Int. Cl. H04M 11/00

(52) U.S. Cl. 379/90.01

(57) ABSTRACT

The invention relates to a mobile electronic computer unit (1) particularly of the type of a so-called personal data assistant (PDA) or handheld computer, comprising a software-controlled processor unit (3); at least one storage device (4) connected to the processor unit for storing software modules and/or data to be processed; at least one display device (8) for displaying visually detectable information; and at least one input device (10) for at least influencing the operational functions of the computer unit (1) and/or for inputting data. The display and input devices (8; 10) are preferably functionally combined, structurally superimposing one another as a type of display screen sensitive to touch, e.g. in the form of a touch screen (12). At least one interface (6; 7) designed as an interface of the standard type, is arranged on the housing (2) of the computer unit (1). Said interface is provided for linking it with peripheral electronic and electric equipment such as, e.g. a personal computer. Said standard-type interface (6; 7) or an independently designed interface is adapted for linkage with at least one safety switch element (13) of the type of an emergency “OFF” switch (14) and/or an approval key (15). Furthermore, the invention comprises a module-like expansion device for extending mobile computer units of the standard type.

The invention relates to a mobile computer unit as defined in claim 1; its application as defined in claims 13, 14, as well as to an expansion device for extending a commercially available electronic computer unit as characterized in claim 15. Furthermore, the concrete invention relates to a mobile computer unit as characterized in claim 39, as well as to a manual terminal according to claim 52; and to a supplemental device or wireless communication system as defined in claims 57 and 61.

Mobile computer units with compact dimensions for personal use are widely in use and generally referred to as PDA's (Personal Data Assistants) or handheld computers. The functions of such mobile computer units of the standard type currently comprise, for example management functions for personal data, calendar functions, deadline management, memo functions, and in many cases also a wireless capability for communicating with various networks. Such wireless communication capability comprises, for example mobile telephony via a publicly accessible telecommunication network, Internet access, “blue-tooth” interfaces, or other possibilities for accessing locally accessible networks (LAN's). In most cases, such mobile, compact computer units comprise display devices capable of displaying graphics permitting color representations in many cases as well. Also touch screens for graphic visualization and simplified entry of data or commands are customarily available with such mobile computer units in many cases. Loudspeakers for sound signaling or information output are also available in most instances.

Furthermore, mobile, i.e. portable computer units with integrated position acquisition systems exist, which permit the detection or determination of the given actual position of such computer units, and allow the user to be presented with information depending on the place and time, as described, for example in U.S. Pat. No. 6,177,905 B 1. Extension modules, which permit the realization of additional functions, are known as well. For example, the combination of a mobile computer unit or PDA with a mobile telephone, a fixed-network telephone or a keyboard is disclosed in U.S. Pat. No. 5,625,673 A. Applications for mobile computer units or PDA's for the medical field are known from WO 01/52727 A1. An optional expansion module for mobile computer units or PDA's for realizing a camera function is known, for example from U.S. design Pat. No. 449,848 S. Known is also the application of PDA's for remotely controlling consumer appliances in the home application area via infrared according to WO 01/24473 A1. However, the functional capabilities of the known mobile computer units are not satisfactory for all fields of application.

The present invention is based on the problem of rendering standard mobile computer units more suitable for controlling industrial machines, and to expand mobile computer units of the standard type in such a way that the latter can be employed in combination with industrial machine controls while taking into account high safety requirements, if need be.

Said problem of the invention is resolved by the features according to claim 1.

It is beneficial in this connection that even a mobile computer unit of the type commonly available in the market, in particular a PDA or handheld computer, is functionally extended in such a manner that it can be employed in connection with industrial machine controls and will satisfy high safety requirements in such applications. In particular, the mobile computer unit can be tied also to electronic machine controls, where functions or processes of the machine or plant that are critical to the safety of the latter, are controlled with such computer units, and can be executed or stopped as required. An important advantage of such an embodiment lies in the fact that at least some of the functions available with commercially available, standard computer units can be practically employed in conjunction with an industrial control system. It is, therefore, particularly possible to provide industrially applied manual terminals, which, in conjunction with electronic machine control systems, offer high functional diversity. The cost expenditure for such a terminal can be kept low on account of the components or standard functions that are available in connection with standard-type computer units in any case. The compact design of such computer units, which have been advantageously tested in thousands of instances with extremely high functional stability in many cases, permits such manual terminals for industrial machine controls to be basically carried along always, and to thus keep them available at all times. Another important benefit of such a design is that the user can quickly become familiarized with its operation because a user surface is present that is at least partly known already to the user from case to case. The expenditure for training users in the correct operation or available functions thus can be reduced. Particularly the application of generally customary mobile computer units as a universal “man-machine-interface” in the field of industrial machine control therefore offers important benefits for both the supplier and user of the computer unit as defined by the invention.

Beneficial is in this connection the further development according to claim 2, as the actual state of the at least one safety switch element can be directly detected and evaluated by the mobile computer unit, and this information can then be made available for further processing or conversion. Moreover, by simply changing the program routines for the software-controlled computer unit, the sequence of functions of the computer unit can be relatively quickly modified and adapted to individual requirements.

It is beneficial in connection with the embodiment according to claim 3 that active transmission or passive loading of the status information of the safety switch element is achieved, and that this information or these commands can be directly converted accordingly by the respective machine control.

The embodiment according to claim 4 is advantageous in that the components of the mobile computer unit are tied to a standard interface of an industrial machine control and can be used as peripheral electronic components in conjunction with the machine control.

By virtue of the embodiment according to claim 5, the computing capacity of the external machine control can be linked with the capacity of the mobile computer unit, so that an increase in capacity is thus achieved both on the side of the mobile computer unit and the side of the external machine control.

It is possible by means of the embodiment according to claims 6 and/or 7 to use the display and/or input capabilities of the standard-type mobile computer unit in a simple manner for visualization and/or control tasks for an industrial machine control system.

The embodiment according to claim 8 permits in a simple manner adaptation of a standard mobile computer unit in order to render an industrial machine control system compatible with defined specifications for its communication interface. Likewise, an adaptation or alteration of such specifications is made possible in a simple manner for setting up different communication links with various machine control systems.

The embodiment defined in claim 9 permits the application of the mobile computer unit for operating and controlling tasks in industrial automation. Likewise, its application for information and status queries or for diagnoses in the service area is made possible. The respective functions can be made available in a simple manner, and called in or executed at any time when required by engaging software modules as required.

The embodiment according to claim 10 provides a compact programming device for an industrial machine control, which can be comfortably carried on the body of the user and is therefore immediately available at any time. A further benefit lies in the fact that carrying the programming device on the body of the authorized user, the risk of it being used by unauthorized third parties is minimized.

In accordance with the embodiment according to claim 11, commercially available or conventional computer units can be effectively employed under raised safety standards in conjunction with safety-relevant applications. For example, it is possible with the help of such software and/or technical hardware means to realize redundant, multi-circuit signal detection, signal transmission, as well as signal evaluation, and to thus achieve so-called “single-error” safety.

It is beneficial in connection with the embodiment according to claim 12 that the authorized user is able to access relevant data quickly and comfortably and rely on defined adjustments, which substantially raises the comfort of using the device and permits reducing the expenditure for operating it.

The application of a standard computer unit for the purposes according to claim 13 or 14 permits providing manual terminals at relatively favorable cost for influencing and/or monitoring industrial machine controls, or machines or plant equipment controlled therewith. Another benefit lies in the fact that the functional components of a standard computer unit have been tested in thousands of applications and are available in many cases in technologically matured conditions, which favors the application in conjunction with industrial machine control systems.

An independent solution for the problem of the invention is characterized in claim 15.

It is beneficial in this connection that a standard-type computer unit can be extended modularly in such a manner that it can be employed in connection with industrial machine controls. The optional extension device represents in this connection a kind of “docking station” for standard computer units, so that the functions of general computer units can be expended or adapted as required. Another advantage lies in the fact that relatively favorably priced manual terminals can be created in this way for influencing and/or monitoring industrial machine controls or the machine or plant equipment controlled therewith. In particular, the capacity or functionality of commercially available computer units or their functional components can be used in order to at least partly satisfy or assume the functions of so-called manual terminals or hand-held equipment for operating machine controls. It is possible in many instances to completely dispense with even specially conceived manual terminals for industrial machine controls by combining a commercially available computer unit with an expansion device as defined by the invention. It is particularly feasible to achieve or even surpass with the expansion device as defined by the invention the safety and/or ruggedness and/or operating comfort of specially developed manual terminals for machine control systems.

According to the embodiment as defined in claim 16, it is possible to select the tie-up to the safety switch element deemed the most favorable in the given case. Including an electronic conversion device is particularly beneficial if up-front detection or evaluation or coding of the given state of the safety switch element is to take place, and the signals of the upstream conversion device have to be transmitted to units downstream, or the respective commands have to be converted by subsequent units, in particular by the external machine control. A direct tie of the safety switch element to the interface to the receivable or allocable computer unit is beneficial if the computer unit employed is already capable by virtue of, for example technical software programs to directly detect and evaluate the state of the safety switch element. Alternatively to the above or in combination therewith, the safety switch element can be directly switched to the external interface of the extension device for directly tying it into the safety circuit of a machine control system. Such direct wiring permits obtaining a simple and functionally reliable structure.

With the embodiment according to claim 17, the benefit gained is that a common interface is formed for communication signals or data and for passing on switching commands of the safety switch element, which renders any inadvertent omission of one of the two signal connections impossible. This means, furthermore, that the safety switch elements are always functionally tied into the machine control as well if the computer unit or the expansion device are employed in conjunction with an external machine control.

Simple coupling of the computer unit with an external machine control is achievable with the embodiment as defined in claim 18. In this connection, the expansion device rather serves as a type of “docking station” for simply switching the computer unit to the interface of the machine control, for which provision is made accordingly.

By virtue of the embodiment according to claim 19, information or signal transmission is made possible starting from the safety switch elements to the mobile computer unit even if the expansion device and a computer unit associated therewith are not exactly positioned in relation to one another, which is absolutely required in connection with any design of contact connections requiring relatively high positioning accuracy.

By virtue of the embodiment according to claim 20, the intended area of the expansion device for a normal allocation can be made clearly and, at the same time, the allocation of invalid or non-provided computer units can be prevented in a simple manner.

The embodiment according to claim 21 achieves mechanical coupling between the expansion device and a computer unit intended to be assigned thereto. In this way, any unintended separation between said components can be excluded, and a coherent multi-component structural unit is created.

The manual build-up of plug connections or other types of coupling for creating a signal or data transmission path is dispensed with by the embodiment according to claim 22. The unit comprised of the expansion device and the computer unit corresponding therewith thus can be combined in an effortless manner and readied for operation in a short time, and then separated and dismantled again into the per-se independent components “computer unit” and “expansion device”, if need be. The modular build-up of the system comprised of the computer unit without the expansion device also permits the application of the computer unit alone if this is useful, for example if the latter is employed for application in another environment, or for other, for example private purposes, or for evaluating data acquired by the computer unit in other locations such as, e.g. in an office.

The expansion device as defined by the embodiment according to claim 23 or 24 represents a type of electronic adapter, which permits simple and short-term tie-up of a conventional computer unit to the corresponding interface of an industrial machine control system. In particular, with the help of technical software means, technological compatibility of the interface of the computer unit with the communication interface of the machine control is achieved in a simple manner. Likewise, such or also independent technical software means can be employed for maintaining or converting safety logs for safely transmitting and/or receiving data or signals.

Owing to the embodiment according to claim 25, the given state of the safety switch element, which has to be activated manually, can be reliably detected and evaluated and made available passively, or transmitted actively for converting the given actual reporting and signaling state for the external machine control. In addition, the additional input or display means on the expansion device can be acquired in this connection, and said signals or switching commands can be actively transmitted to the external machine control in accordance with the required communication or bus log, or made available in terms of a so-called “polling mode”.

High safety-technical requirements can be taken into account by virtue of the embodiment according to claim 26, so that commercially available or conventional computer units can be employed in conjunction with safety-relevant applications as well. With the help of such soft- and hardware means, it is possible to realize, for example redundant multi-circuit signal acquisition, signal transmission and signal evaluation, and thus achieve the so-called “single-error” safety. It is particularly possible to make provision for one or more processors on each of the transmitter and receiver sides of a transmission line, whereby each processor independently acquires the information or signals and transmits the latter to the assigned external processor for evaluation. In particular, through multiple or multi-circuit designs and/or evaluations on the side of the computer unit or expansion device and on the side of the machine control, it is possible to raise the safety or reliability of the system comprised of the expansion device and computer unit and the industrial control system. With multiple or multi-circuit arrangements, the redundant components may also monitor one another by comparing results, and, if error conditions are detected, may trigger suitable safety-specific functions, or stop functions critical to safety. Through measures such as, for example formation of check summations and/or time information and/or sequence information, or other check or test information, such measures being preferably realized with technical software means, and their tie into the signals or data packets to be transmitted or received, it is possible to further raise the safety and reliability level of the system.

The embodiment according to claim 27 permits implementing measures for identifying the user, which allows authorization control, on the one hand, and/or graduation of authorizations for different users on the other. In particular, different prioritized authorizations can be issued or granted in this way, and individual pre-setting of system access can be controlled as well.

The embodiment according to claim 28 permits preset or predefined user profiles to be called in or set quickly, so that protracted adjustment procedures can be dispensed with. In addition, the risk of erroneous adjustments can be minimized in this way. Moreover, different user groups can be defined, whereby only the required or relevant system adjustments can be rendered accessible to individual persons.

Owing to the embodiment according to claim 29, it is possible to form large-dimensioned or particularly ergonomic input elements that increase the operating comfort or highly sensitive execution of delicate functions or control tasks.

By virtue of the further development according to claim 30, primarily the execution of functions of movement is feasible. For example, so-called “teaching” of robot movements is rendered sensitive and, most of all, made intuitive.

The embodiment as defined in claims 31 and 32 provides additional mechanical protection from failure for an allocated computer unit, and overall comparatively high ruggedness, which may further enhance the applicability in the relatively harsh industrial environment.

The embodiment according to claims 33 and 34 may distinctly prolong the readiness for use and duration of service of the expansion device in conjunction with the computer unit. Particularly in connection with energy-intensive functions such as, e.g. during radio operation or when using sound or optical signaling, the capacity and also the performance of the computer unit can be raised under certain circumstances.

The nearly unrestricted mobility of the user of the device within a defined range is achieved through the embodiment as defined in claim 35.

By using standardized interface and transmission logs according to claim 36, it is possible to employ numerous interface components quickly and at favorable cost, such components being available in the finished and tested condition. Furthermore, this simplifies certain permitting and certification procedures, or the latter may be dispensed with entirely.

With the help of the embodiment according to claim 37, the interface that is available on the computer unit for transmitting and/or receiving signals or data, to begin with, can be used vis-à-vis a machine control system, whereby such signals or data have to be displayed on the expansion device and/or were entered on the latter.

A reliable and widely used communicative tie to an industrial machine control system is achieved through the embodiment as defined in claim 38.

Independently thereof, the problem of the invention is resolved as well by a computer unit according to claim 39.

Benefits and effects ensuing therefrom can be derived also from the benefits specified in connection with the embodiment according to claim 1. It is beneficial that such a PDA, which is conceived for industrial applications, can be used primarily by technicians employed in the industrial service and maintenance department. An important advantage lies in the fact that multifarious personal adjustments, system service routines, data, measurement and comparison values and the like, are available on the device of the user, and that such user is always communicating with the machine control system of the machine or plant equipment via the user interface and the user surface, with which such user is familiar. Important operating and process data can be read out, recorded and also changed in this way within the immediate vicinity of the machine. Critical operating conditions, if any should occur, can be directly and automatically signaled to service technicians who happen to pass by, so that they can immediately implement the required remedies. Savings can be achieved mainly through the joint use of the input and output means of the standard PDA's, which are available, to begin with, and are employed as peripheral components. A standardized terminal function is realized for industrial equipment and machines through the computer unit or PDA that is provided for personal purposes. A performance feature of a computer unit so adapted can be compared also with a browser function for machine controls.

With the embodiment according to claim 40, it is possible to acquire and evaluate the given state of actuation or of the safety switch element with high priority in terms of function and time.

The switching state information or signals of the safety switch element can be reliably coupled into the computer unit by means of the embodiment according to claim 41.

The safety switch elements are ergonomically favorably arranged and within reach of the user owing to the design according to one or more of claims 42 to 45. In addition, the safety switch elements are in this way a fixed component of the computer unit and thus quasi-“unlosable”, or inseparably coupled with the latter.

According to the further development of the invention as defined in claim 46, movements or functions critical to safety can be executed only if one of the approval keys is depressed in combination with the respective functional element of the computer unit. In particular, the actual machine command or displacement movement is exclusively triggered only if an approval key and an additional control element are actuated simultaneously and therefore with high probability intentionally, so that unintentional switching commands that could lead to hazardous situations or damage, are almost entirely excluded.

The embodiment according to claim 47 permits the approval keys to be easily reached and protects the sensitive electronic components of the computer unit at the same time against soiling.

Slip-proof handling of the computer unit is achieved owing to the embodiment according to claim 48. Furthermore, the safety switch element can be actuated starting from the fingers of the hand in which the housing of the mobile computer unit is being held.

The embodiment according to claims 49 and 50 permits reducing the number of independent switch elements on the computer unit. In addition, it is particularly beneficial that an almost instantaneous transition can be induced, starting from the approval position to the emergency “OFF” position.

Owing to the embodiment according to claim 51, an emergency situation can be managed with the help of a quasi-spasmodic or abrupt force acting on the actuation element, with no additional shifting distance being necessarily required for the actuation element.

An independent solution to one of the problems of the invention is achieved with a manual terminal as defined in claim 52.

It is beneficial in that connection that by jointly using the display and input capabilities of the standard-type computer unit or a so-called PDA, it is possible to achieve substantial savings for creating industrial manual terminals of the type here under discussion. A relatively great variety of functions is nonetheless achievable with such a hand-held terminal at relatively favorable cost. For example, in addition to the graphic display and input capabilities, also the personal user profiles, the data memories, the local and/or external document or data access capabilities via networks, and the telephone option or the like can be used in conjunction with industrial machine controls. This means that the activities to be carried out can be distinctly supported or facilitated also with the standard functions of the mobile computer unit.

Machines, for which increased safety requirements need to be satisfied, can be operated and monitored by means of the embodiment according to claim 53 as well.

The production or developments costs for the manual terminal of the type defined by the invention can be reduced further owing to the embodiment according to claim 54.

The further development according to claim 55 is advantageous in that the joint employment of the wireless communication interfaces of the mobile computer unit or PDA means that use is made of thoroughly tested, reliable functional elements, and that the mobility of the user of the manual terminal is not restricted or hindered by cable connections.

The reliability and operating efficiency of the computer unit can be additionally raised by the advantageous further development according to claim 56. The increased operating efficiency of wireless signal or data transmission leads to raised functional reliability especially in view of its application in conjunction with industrial machine controls.

Irrespectively of the above, the embodiment according to one or more of claims 57 to 60 permits a standard-type computer unit to be optionally extended in such a way that such a mobile computer unit or manual terminal of the type defined by the invention can be linked with industrial machine controls without problems. In particular, this permits simple later refitting of existing machine controls or optional expansion of actual machine controls for signal or data transmission via radio signals.

Independently thereof, a wireless communication system according to claim 61 is advantageous in that it permits later refitting or optional functional expansion of machine controls for radio signal or data transmission as well.

The invention is explained in greater detail in the following with the help of exemplified embodiments shown in the drawing, in which:

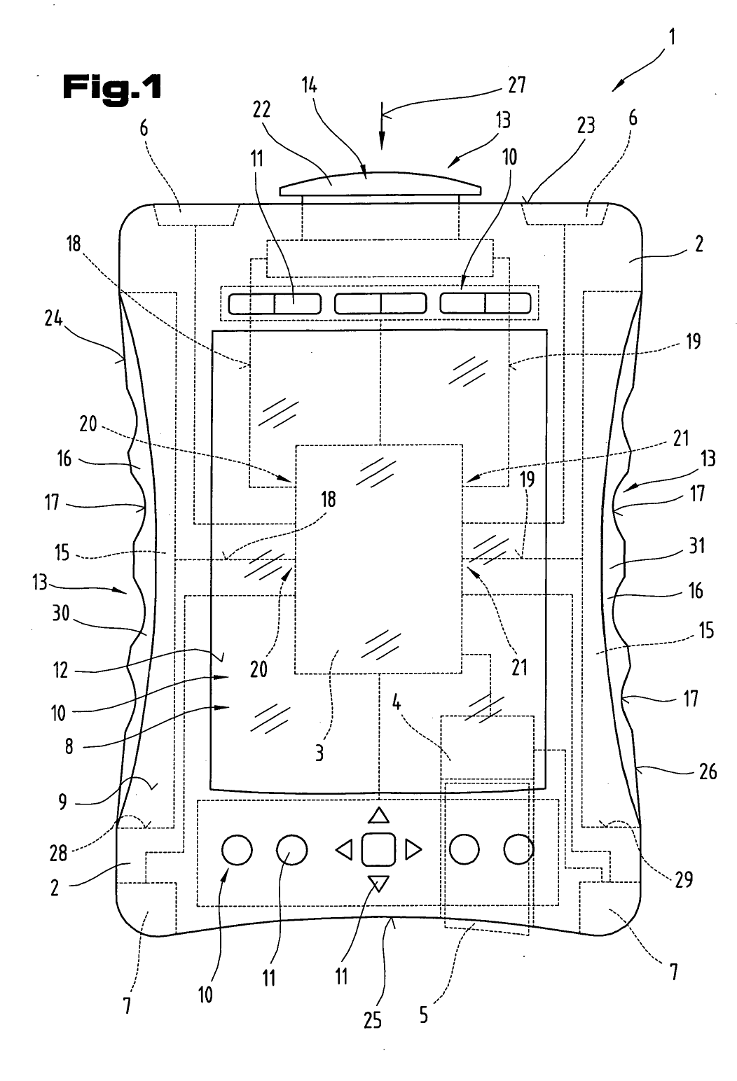

FIG. 1 shows a top view and simplified schematic representation of a mobile computer unit designed or modified as defined by the invention, with safety switch elements for safely tying it to external industrial machine control systems.

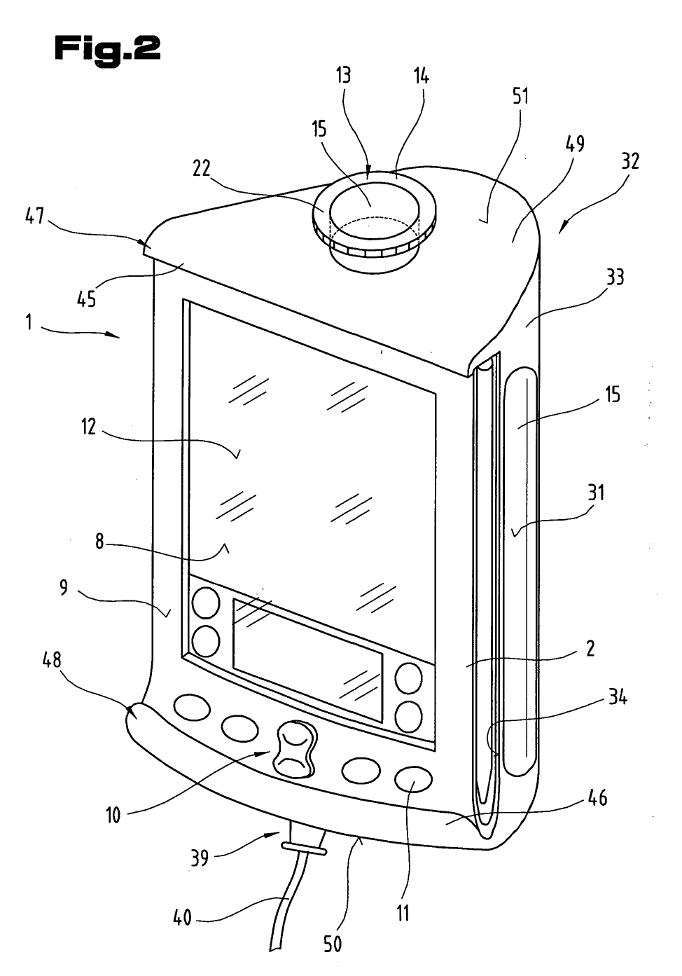

FIG. 2 is a simplified perspective view of an embodiment of a standard-type, commercially available computer unit in connection with an expansion device as defined by the invention, and safety switch elements for tying it to industrial machine controls.

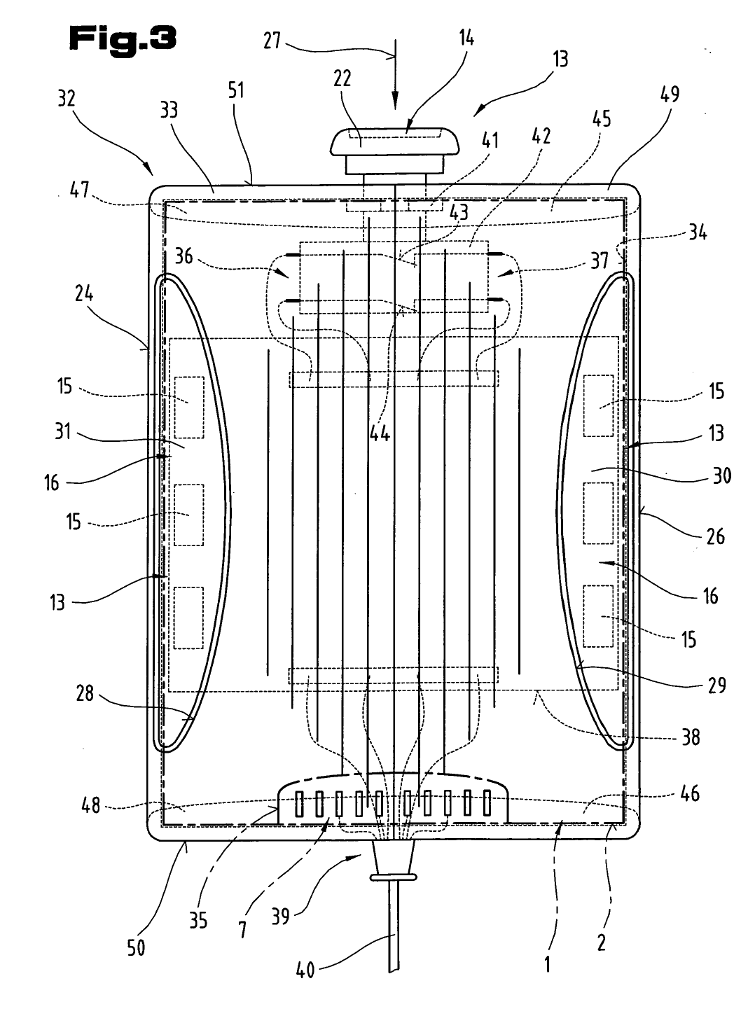

FIG. 3 is a back view of the modular expansion device for extending a standard-type mobile computer unit according to FIG. 2.

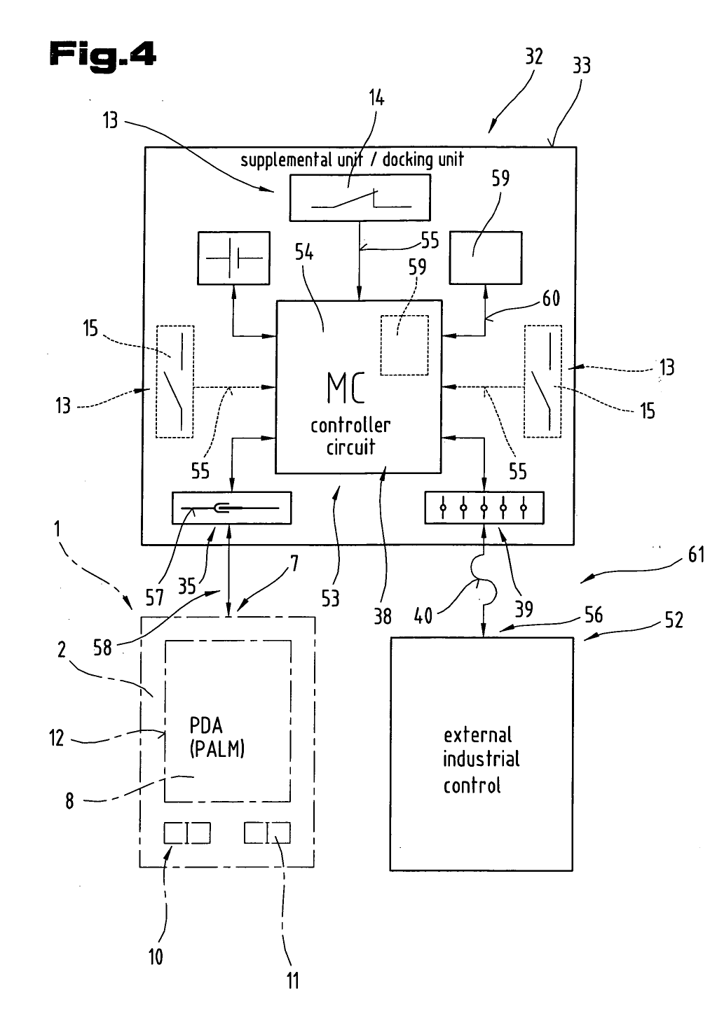

FIG. 4 is a block diagram of a feasible embodiment of system interconnections between a mobile computer unit, an expansion device and an external industrial machine control.

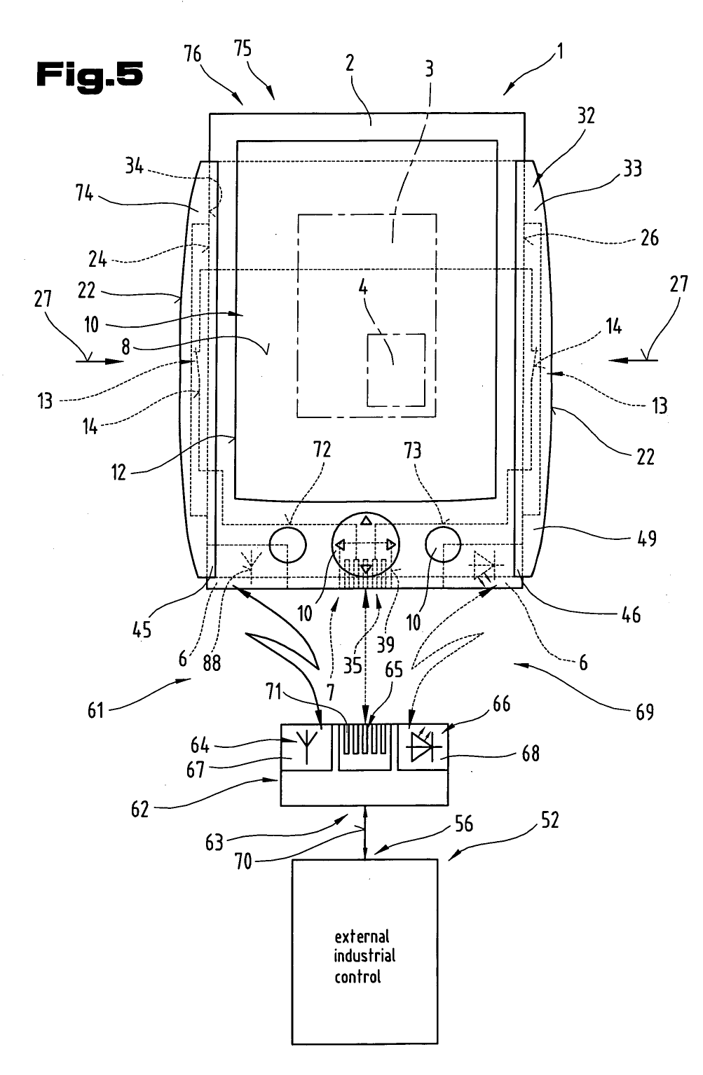

FIG. 5 is a standard-type computer unit in connection with safety switch elements cooperating with an expansion device for linking it wireless with electronic industrial machine controls.

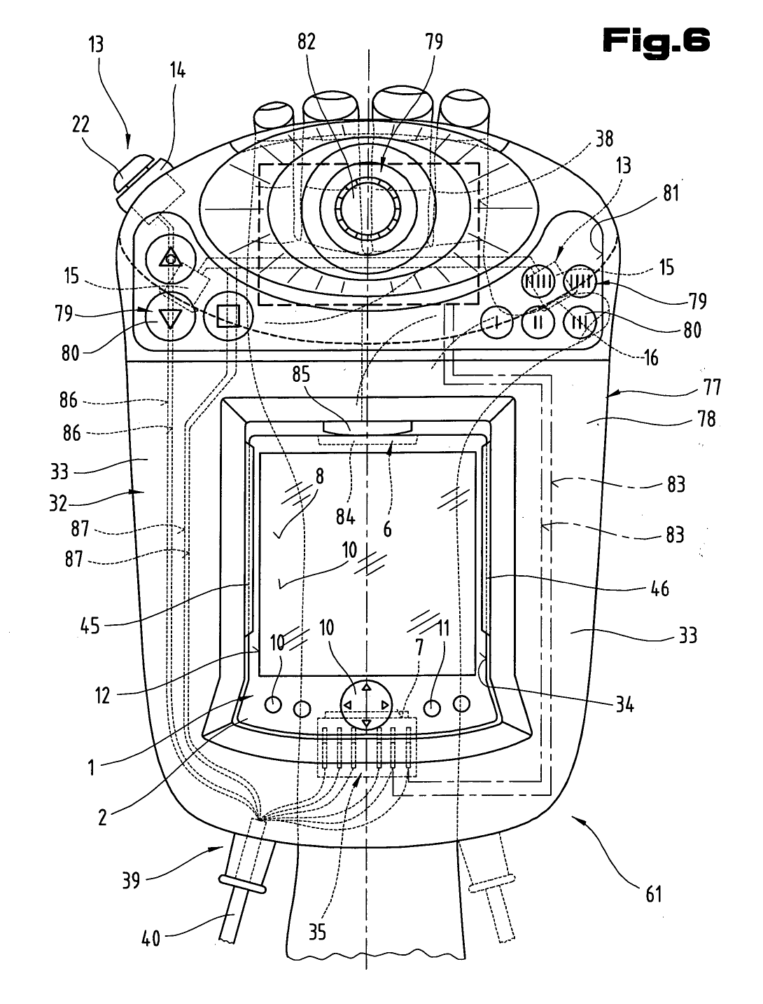

FIG. 6 is a top view and simplified schematic representation of another embodiment of an expansion device as defined by the invention, for standard-type mobile computer units; and

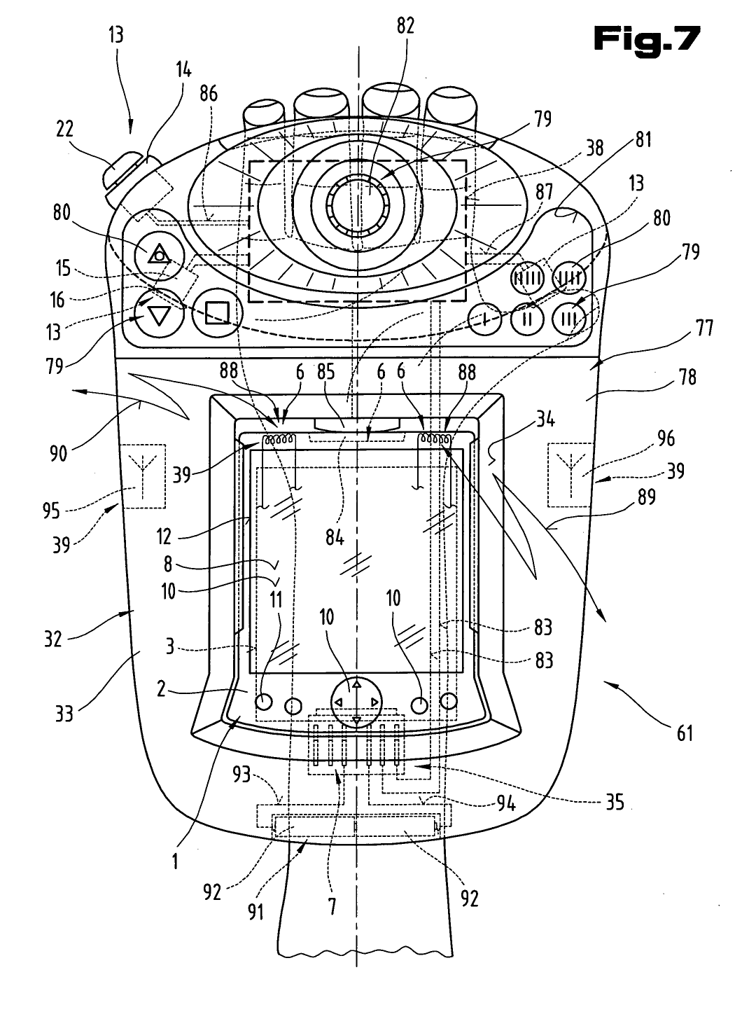

FIG. 7 is a top view and simplified schematic representation of yet another embodiment of an expansion device as defined by the invention, for standard-type mobile computer units for wireless connection to an external industrial machine control.

Its is noted here by way of introduction that in the various embodiments described herein, identical components are provided with identical reference numerals and identical component designations, whereby the disclosures contained throughout the present specification are applicable to identical components with identical reference numerals and identical component designations in the same sense. Furthermore, positional data such as, e.g. at the top, bottom, lateral etc. selected in the specification relate to the figure directly described and shown, and, where a position has changed, have to be applied to the new position in the same sense as well. Moreover, individual features or combinations of features may per se represent independent inventive solutions and solutions as defined by the invention.

FIG. 1 is a top view of a first embodiment of a mobile computer unit 1 as defined by the invention. A housing 2 of said computer unit 1 is formed in this connection as compact as possible, so that is can be held without effort in one hand of the user. The housing 2 is preferably shaped in such a manner that its underside rests at least partly on the palm of the hand, and that its side or wall surfaces opposing one another can be accommodated between the fingers and the ball of the thumb, so that it can be clamped within the palm of the hand.

The basic structure and basic components of the mobile computer unit 1 is formed by a so-called handheld PC or Organizer or Personal Data Assistant (PDA). The essential functional components of the computer unit 1 are thus provided by a commercially available widely used microcomputer or personal organizer having about the size of the palm of a hand and the format of garment pockets. The basic components of the computer unit 1 as defined by the invention are therefore formed by a generally customary organizer or so-called PDA, which is relatively widely used as compared to manual devices employed for operating industrial machine control systems. Such mobile microcomputers permit personal data management, deadline management, memorandum storage and the like, among other things, and general comprise a calendar function as well. The wide use and availability of such standard-type microcomputers of PDA's, which are produced in high numbers of units, contributes to the economy or cost/efficiency ratio of the special computer unit 1 described in detail hereinafter, which can be extended by supplementary devices in another embodiment.

The Personal Data Assistant (PDA) or handheld computer used for the computer unit 1 as defined by the invention comprises a software-controlled processor unit 3 or corresponding micro-controller as the central data management or computer device of the type of a central processing unit (CPU).

Said processor unit 3 is connected to at least one electronic storage device 4, or at least a part of the storage device 4 may be directly integrated in the processor unit 3. The storage device 4 serves for storing software modules that have to be serviced, and/or for buffering or permanently storing data. The storage device 4 thus comprises both at least one program memory and at least one data or main memory. The storage device 4 is preferably formed by RAM-, EEPROM- or flash storage modules.

In addition to the storage device 4, which is integrated fixed in the housing 2, the computer unit 1 may comprise an exchangeable or replaceable electronic storage medium 5 as well, as indicated by the dashed lines 5. Said storage medium 5 may be formed by memory cards or memory sticks of any manufacturers or suppliers. Owing to said exchangeable storage medium 5 of the computer unit 1, data or programs to be processed by the processor unit 3 therefore can be exchanged or changed in a simple manner. Furthermore, by virtue of said storage medium 5, which can be removed or changed when required, makes it possible in a simple manner to transfer data stored by the processor unit 3 on the storage medium 5 to other electronic data processing devices such as, for example personal computers or laptops, and to have them read out and processed by the latter accordingly.

The storage device 4 is directly and/or indirectly connected to at least one external interface 6, 7 via the processor unit 3 in order to permit communication or data exchange with peripheral electronic devices. Preferred is in this connection at least one wireless interface 6 such as, e.g. a standard-type Bluetooth, Wireless-LAN-, GSM-, UMTS-, or infrared interface. Preferred is also at least one wire-bound and contact-equipped interface such as, e.g. an RS232, USB, firewire or any other, generally used interfaces. Of importance is that a data connection to peripheral electronic devices can be built up via the standard-type interface 6, 7 of the computer unit 1 by means of radio signals, infrared, sound waves, contact interfaces or cable connections.

The external interface 6, 7 on the computer unit 1 as defined by the invention is therefore formed by a standard-type data or communication interface that is available on the data processing or data managing device of the type of a PDA used in any case, the latter being standardized to the greatest possible extent.

Furthermore, the mobile computer unit 1 comprises at least one display device 8 for the visually detectable output of information or data. Said display device 8 is preferably formed by a display capable of displaying graphics and suitable for displaying graphics, texts or objects preferably in different colors. The display device 8 is dimensioned with a relatively large-sized screen and preferably takes up more than half of the surface area on the top side 9 of the housing 2.

Furthermore, the computer unit 1 is comprised of at least one input device 10, which is suitable at east for influencing the operational functions of the computer unit 1 and/or for entering data in the computer unit 1. The input device 1 may have the individual keys 11, depressible or rotary keys, cursor keys, rotational or sliding controls and other input elements such as, e.g. a control stick, a track ball or the like. All of such input elements of the input device 10 are preferably already available on the mobile, data-managing computer unit 1 or handheld PC or PDA employed accordingly.

At least a part of the display devices 8 of the computer unit 1 is functionally combined with a part of the input devices 10 of the computer unit 1. In a preferred embodiment, a display screen sensitive to touch in the form of a so-called touch screen 12 is formed, in connection with which a graphic display device 8, in particular a display, or a touch-sensitive input element superpose each other. The individual display devices 8 may be provided also in the form of luminous means such as, e.g. lamps or LED's.

It is important that the computer unit 1, which is equipped with the mobile computer “core” of a so-called personal data assistant (PDA), the latter being known per se, is provided with at least one safety switch element 13 permitting triggering or the execution of safety-critical or potentially hazardous functions or conditions and/or their reliable termination. In particular, at least one safety switch element 13 having the function of an emergency-OFF-switch and/or an approval key 15 are provided on the housing 2 of the computer unit 1. However, the idea of the invention also comprises safety switch elements 13 of the type of so-called quick-stop keys or safe tipping keys or other switching elements requiring increased functional reliability in view of their task and associated function. Owing to said safety switch element 13, which can be actuated by the user or operator when required, the computer unit 1 can be tied also into industrial machine controls or automation systems where functions critical to safety, for example movement functions or processes of any type that are critical to safety, are or have to be executed automatically.

With a safety switch element 13 provided in the form of an emergency-OFF-switch 14, an individual part of the plant machinery or an entire machine can be immediately switched to a safe operating condition in cases of emergency, or if situations should occur that are hazardous to persons, machine parts, or to objects that have to be processed. Such a safe operating condition, upon actuation of the emergency-OFF-switch, is often achieved by immediately shutting down the energy supply to driving aggregates of the machine or technical plant installation. Likewise, such a safe operating condition due to activation of the emergency-OFF-switch 14 on the mobile computer unit by be defined by controlled resetting of moving parts of a technical plant or machine into a defined starting position, or by controlled throttling of the flow of energy or materials. Therefore, any threatening situation that is hazardous to people, or any expected damage to machine parts, tools and/or work pieces, can be abruptly terminated by means of the emergency-OFF-switch 14 on the computer unit 1 even by persons nor familiar with the installation. For this purpose, the emergency-OFF-switch 14 is formed in such a way that it is obviously recognizable as such on the housing 2 of the computer unit 1. This can be achieved by providing the safety switch element 13 with a defined shape, color and/or text marking that is proposed to some extent for defined safety switch elements in relevant standards and safety guidelines depending on their function. The emergency-OFF-switch 14, in particular its activating member, is preferably colored in red. Furthermore, said activating member of the emergency-OFF-switch 14, which is visibly protruding from the housing 2 of the computer unit, may be arranged in a preferably yellow framing.

Instead of or in combination with an emergency-OFF-switch 14, it is possible also to make provision for a so-called quick-STOP-switch that is also employed for safely shutting down a machine or plant for preventing damage, but not for terminating conditions that pose a hazard to people. Such a quick-STOP-switch is provided with a different color so as to avoid the risk of any confusion with an emergency-STOP-switch 14. Relevant guidelines permit comparatively less functional reliability for such quick-STOP switches. In particular, a quick-STOP switch may not be functioning when the manual operating device is switched off; however, it must be visible nonetheless, whereas an emergency-OFF-switch 14 has to function always if it is recognizable as an emergency-OFF element.

With a safety switch element 13 provided in the form of an approval key 15, it is possible to induce machine or process processes critical to safety, and/or to execute movement functions that are to be rendered safe only if one of the approval keys on the mobile computer unit 1 and the respective operating element of the input device 10 are actuated simultaneously. The risk of any unintended triggering functions on technical equipment therefore can be minimized to the greatest possible extent. Likewise, in the presence of any defect of an operating element, any displacement movement or function in process can be stopped with the approval key 15, which is designed by safe technology. The approval key 15 formed in or on the housing 2 of the computer unit 1 can be generally referred to also as a dead man's key and provide the functions of the latter.

Instead of using a separate approval key 15, it is possible also to design each of the other operating elements or keys 11 of the input device 10 in safe technology for operations critical to the safety, in particular in the form of multi-circuit elements. In this way, not only unintended actuation is avoided, but it is assured that when the respective key is released, the movement or function is reliably interrupted, and can be restarted then only if the element is actually actuated. One single error in the entire chain of signals between the operating element or key 11 and the control cannot induce this movement or function owing to a logic AND-condition or AND-link of the switching commands in the individual signal lines.

It is conceivable in any case to provide the safety switch element 15 on the mobile computer unit 1 only in the form of one emergency-OFF switch 14 or only at least one approval key 15. An approval key 15 with panic-STOP function is usually designed in the form of a multi-stage, particularly three-stage safety switch element 13. In the starting or idle position of said safety switch element 13, neither approval for executing any functions of the external machine control that need to be protected is given, nor is any emergency STOP condition induced. In the second switching stage of said combined safety switch element 13, functions are then permitted that are critical to the safety or have to be protected against unintentional initiation. In a further, in particular third switching stage, which is arranged downstream of the approval position in relation to the direction of actuation of an actuating element 16 of the approval key 15, an emergency STOP function may be additionally implemented for a technical plant or machine. Such a safety switch element 13 therefore comprises a non-actuated resting stage, an approval stage and an emergency-STOP-stage.

It is possible also to provide for a safety switch element 13 with an approval and emergency-STOP-function whose actuating element 16 can be shifted from the starting or resting position into only one single position tat is spaced from the former position and in which both the approval and the emergency-STOP-functions can be selectively activated. Such a multifunctional safety switch element 13 is designed in this connection in such a way that if a predefined limit value of the force acting on the actuating element 16 is exceeded in the approval stage, an emergency STOP or panic situation is recognized, where-upon an emergency STOP condition is initiated in the plant or machine control system. Such a safety switch element 13 preferably comprises a pressure of force sensor via which a actuation forces acting on the actuating element 16 can be detected and subsequently evaluated electronically.

As an alternative to the above, provision can be made on the computer unit 1 for a safety switch element 13 with a pressure or force sensor in connection with which an approval function is translated in a first range of the pressure or force acting on the actuating element 16, and the emergency-STOP-function is fixed when such a defined value range is exceeded. This means that a safety switch element 13 can be realized that comprises an actuating element 16, which per se in immovable, but nonetheless has the two or three switching stages, particularly an idle stage and an approval or panic stage. It is beneficial in this connection that such a safety switch element 13 can be designed in a simple and particularly space-saving manner while nonetheless being quite rugged with a long useful life and insensitive to fouling. The space-saving structure of a safety switch element 13 formed by at least one pressure or force sensor benefits its unproblematic integration in the compact housing 2 of a handheld computer or PDA densely fitted with electronic components. The insensitivity to fouling and the long service life or ruggedness of such a safety switch element 13 ensuing from its simple mechanical structure, with no or just a comparatively few moving components, are especially advantageous for the intended application of the computer unit 1 in the relatively harsh industrial environment of machines and machine controls.

The safety switch elements 13, which are built into the housing 2 of the computer unit 1 or secured on the housing, thus permit the use of the mobile computer unit equipped with a conventional “computer core” in conjunction with industrial machines or automated plant equipment, and with manipulators or robots. The mobile computer unit 1 as defined by the invention serves in this connection primarily as an operating device for machines and plants, and as a teaching and programming panel for robots, or for test, maintenance and start-up purposes for technical plants with an electronic control system. In addition to serving for the active operation and/or programming of machines or their controls, the portable computer unit 1 as defined by the invention may serve also for passively observing and visualizing the routines or data of technical plant equipment.

The actuation elements 16 for actuating the one or more approval keys 15 on the computer unit 1 are usually formed within the direct gripping or holding range for the housing 2. Within this gripping or holding range of the housing 2, it is possible also to make provision, for example for the recesses 17 for the fingers, which facilitate safe and non-slip gripping and holding of the housing 2. Said gripping and holding area of the housing 2 is preferably formed with elastic pliability, and this elastically yielding area may at the same time represent a component of the actuating element 16 for an approval key 15. It was found to be favorable if this elastically yielding area is formed in the longitudinal edge sections of the housing 2, so that when the housing 2 is picked up with one hand, at least one approval key 15 can be comfortably actuated via at least one finger of the hand in which the computer unit 1 is accommodated or held. When functions of the machine to be controlled are executed or initiated that are critical to the safety or are posing a hazard, at least one of the approval keys 15 has to be shifted into the approval position, so that the actual input element of the input device 10 can become functionally active for executing or initiating any such actions that are critical to the safety.

So as to be able to detect the switching or actuation state of each of the individual safety switch elements 13, the latter are connected to at least one input 20, 21 of the processor unit 3 via at least one line 18, 19. Via said line connections leading to the at least one safety switch element 13, it is made possible for the processor unit 3 to query or elicit the actual switching condition present at the given time, so that thereupon, the respective functions can be translated or initiated accordingly in the external machine control, to which the mobile computer unit 1 is connected at least in terms of technical data communication.

If an independent emergency-OFF switch 14 is present, the latter preferably comprises an actuating element with a relatively large surface area, e.g. a mushroom-shaped actuation element 22 that protrudes vis-à-vis the surface of the housing 2, so that it can be recognized more easily, readily accessed and reliably actuated. Like the approval key 15, the emergency-OFF switch 14 is preferably accommodated in one of the lateral wall zones or edge sections 23 to 26 of the plate- or panel-shaped housing 2. The direction of actuation 27 of the safety switch elements 13 or of least of the emergency OFF switch 14 is preferably extending as parallel as possible to the flat top side 9, or substantially approximately parallel to the input and output plane of the touch screen 12, or substantially parallel to the lower flat side of the housing 2. It was found to be favorable if the emergency-OFF switch 14 is arranged in the edge zone 23 of the housing 2 that is positioned at the top or in front when the computer unit 1 is in the position in which it is used, and if provision is made for at least one approval key 15 in each of the edge zones 24 and/or 26 of the housing 2 for the secured or exclusively intentional execution of functions posing a danger potential.

In this connection, the approval keys 15 may be accessible or operable via the break-throughs 28, 29 in the housing 2, the latter being dimensionally stable per se. In this case, the break-throughs 28, 29 and the approval keys 15 are covered by a elastically yielding, for example rubber-like membrane 30, 31, so that the interior of the housing 2 with the computer “core”, the other electronic components and the approval keys 15, is defined at least dust-proof versus the environment or atmosphere of the computer unit 1 as defined by the invention. Said elastically yielding membrane 30, 31 also represents a cover element for the approval keys 15 formed in the housing 2, and may at the same time also form the recesses 17 for the fingers for safely gripping the housing 2 in a slip-proof manner. Said elastically yielding and resetting membrane 30, 31 on the largely dimensionally stable housing 2 quasi represents an “upstream” actuation element 16 for the approval keys 15.

In this connection, the elastically yielding membrane 30, 31 and the approval keys 15 may be formed in the edge zones or edge sections 24, 25 of the housing 2 on the longitudinal side, and may be arranged in a manner such that they are placed within reach of the finger tips of the hand of the user holding the mobile computer unit 1. Comfortable actuation of the latter is therefore assured, and the second hand or its fingers thus remain freely available for operating the computer unit 1 as defined by the invention.

As explained in detail in the following, alternatively or in combination with discretely structured safety switch elements 13, it is possible also to implement the functions of an emergency OFF switch 14 and/or an approval key 15 and/or a safe tip-key via the contact-sensitive display or touch screen 12 of the computer unit 2 as defined by the invention. If this is the case, it would be possible to dispense with independently structured safety switch elements 13 on the commercially available “computer core” or conventional hand-held computer. In particular, by detecting the height and/or impulsiveness and/or the size of a surface area on which the force exerted by a user is acting on the touch-sensitive display or touch screen 12, it would be possible then to recognize an emergency or panic situation, and the required measure, particularly an emergency stop of the technical plant or machine would thereupon be initiated by an external machine control and/or directly by the computer unit 1.

FIGS. 2 and 3 show another exemplified embodiment of a computer unit 2 realized as defined by the invention. Said computer unit 1, which is available as a standard unit in the sector of consumer products, is applicable for operating and/or monitoring and/or programming industrial machine control systems that are basically capable of functioning independently. Identical reference numerals are used for components already described above, and the preceding descriptions are applicable to identical components with identical reference numerals in the same sense.

In the present embodiment, provision is made for a structurally independent expansion device 32, for coupling the latter with a commercially available electronic computer unit 1 of the type of a PDA, organizer or handheld computer that can be carried in one hand. This optional expansion device 32 for extending the general computer unit 1 comprises a frame- or housing-like support body 33 for physically associating said expansion device with or holding a computer unit 1. In particular, a receiving means 34 for receiving the housing 2 of a standardized computer unit 1 is formed on said support body 33. The computer unit 1 may be loosely associated with said structural receiving means 34 on the support body 33, or mechanically connected with the support body 33 via said receiving means 34. Therefore, the receiving means 34 may represent a plug connection or holding system between the computer unit 1 and the support body 33, or a simple support system for accommodating the computer unit 1 in or on the support body 33.

Furthermore, the expansion device 32 or its support body 33 comprises at least one interface 35 for building up a connection with a generally known or standard-type computer unit 1 in terms of data transmission technology. Said interface 35 for transmitting electric signals or data, which is formed on the support body 33 of the expansion device 32, is provided for communicating in terms of data transmission technology with a standard-type interface 7 of a conventional computer unit 1.

It is important that at least one safety switch element 13 of the type of an emergency OFF switch 14 and/or a STOP key and/or an approval key 15 and/or a safe TIPP key are formed on the expansion device 32 or its support body 33. In particular, a safety switch element 13 of the type of an emergency OFF switch 14 and/or an approval key 15 are provided directly on the support body 33 of the modular expansion device 32 for the computer unit 1. By means of combining the generally known, standard-type computer unit 1 with said modular expansion device 32, functions of machines or technical plants that are basically critical to their safe operation, or potentially hazardous, can then be safely executed or initiated and/or monitored and/or programmed in a secured manner. Most of all, preconditions that are primarily relevant to safety and permit a conventional computer unit 1 to be tied to industrial machine controls are satisfied in this manner by virtue of said modular expansion device 32 for extending the standard-type computer unit 1.

The outputs or connections 36, 37 of the safety switch element 13 mounted on the expansion device 32 are connected in this conjunction either directly to a standard-type interface 6, 7 of a computer unit 1 that can be associated therewith, or, with interconnection of an electronic conversion device 38 in the support body 33, to the interface 35 on the support body 33, so as to form a computer unit 1 that can be received or allocated as required. Alternatively or in combination with said direct or indirect connection of the safety switch element 13 to the interface 35 to form an exchangeable computer unit 1, the connections 36, 37 or outputs of the safety switch element 13 also may be connected to an external interface 39 on the expansion device 32. Via said separate interface 39 of the expansion device 32, the latter and/or the computer unit 1 can be connected to an external electronic machine control. In the present embodiment, the external interface 39 of the expansion device 32 is formed by an interface cable 40 leading to a corresponding data input and/or data output of the respective industrial machine control.

In the embodiment shown, an independent converter 38 is provided in or on the support body 33 of the expansion device 32. Said converter 38 detects the actual actuation or switching condition of the safety switch elements 13 present, and further transmits the respective data or information to the computer unit 1 via the interface 35, and/or directly to the external machine control via the external interface 39 and the interface cable 40. The electronic converter 38 mainly serves the purpose of converting the switching signals of the safety switch elements 13 into a format that the computer unit 1 or the machine control 52 is capable of processing. In particular, the converter 38 can be employed for adapting logged communications. In this connection, the converter 38 is capable of adapting or converting logs that are valid on the interface 35 leading to the computer unit 2, to/into logs that are required on the interface 39 leading to the industrial machine control system.

Likewise, the converter 38 can be employed for feeding in or tying in the respective data or signals of the safety switch elements 13 into the household routine of the computer unit 1 or industrial machine control. Therefore, the expansion device 32 with the electronic converter 38 also can be referred to as an adapter or switch-to link with additional safety switch elements 13 for technically effectively tying standard-type mobile computer units 1 to industrial machine controls.

As shown best in FIG. 3, both the electronic converter 38 and the interface 35 are connected to cable lines for connecting them, if need be, to the computer unit 1 with the interface 39 or the corresponding interface cable 40. This means that data or signals can be transmitted from the computer unit 1 to the external machine control and vice versa, and/or data or signals between the electronic converter 38 and the standard-type computer unit 1, i.e. uni- or bidirectionally.

Viewed structurally, one single electrical interface 39 is provided on the expansion device 32. A standard-type computer unit 1 and also at least one safety switch element 13 can be effectively connected to an external electronic machine control via said interface 39, as shown best in FIG. 3.

The embodiment of the expansion device 32 shown, in addition to an emergency OFF switch 14, also comprises two actuation zones having an approval function, said zones being spaced from each other. In particular, a membrane-like actuation element 16 for actuating a multitude of the approval keys 15 disposed underneath, is formed in each of the lengthwise edge zones 24 and 26 of the support body 33. The area of the membrane-like, elastically yielding actuation element 16 is extending here across about one width of the palm of a hand. In this way, a multitude of the approval keys 15 can be comfortably actuated with one finger of the hand. Only one of the multitude of approval keys 15 formed has to be actuated in order to permit release for managing situations that are critical to the safety or dangerous. The approval keys 15 are effectively quasi-connected in parallel. The plurality of approval keys 15 distributed in terms of space on the support body 33 permits a number of holding positions for the expansion device, and at least one of the approval keys is comfortably accessible in many of such holding positions.

The individual approval keys 15 can be secured directly on a component support or small plate of the converter 38 as schematically shown.

Furthermore, the signals or information of the approval keys 15 can be evaluated by the converter 38 as well, and transmitted via the interface 35 to the computer unit 1 and/or directly to an industrial machine control via the external interface 39.

FIG. 3 shows, furthermore, that the safety switch element 13, particularly the emergency OFF-switch 14 is connected with the support body 33 in a fixed way via a plug or screw connection. An electrical contact block 42 of the emergency OFF-switch 14 is accommodated within the support body 33 and connected to the converter 38, or alternatively directly to the interface 39 via a cable line. As explained above, the actuation element 22 protrudes from the general surface of the support body 33 in the form of a mushroom, and said actuation element 22 is raised in some other way vis-à-vis the general surface of the support body 33.

Furthermore, FIG. 3 shows that the emergency OFF-switch 14 or its contact block 42 is preferably a multi-circuit, preferably a two-circuit component. A so-called single-error safety of the safety switch element 34 is achieved in this way, so that in the event of failure of one circuit, the emergency OFF-function continues to be assured by the second circuit of the safety switch element 13. The converter 38 preferably monitors also the proper function of the emergency OFF-switch 14, and, if one circuit fails, generates for the user a warning either via the converter 38 or via the computer unit 1 or via the external machine control. In the exemplified embodiment shown, the two-circuit emergency OFF-switch comprises the two switching contacts 43, 44, which are independent of one another. Said switching contacts 43, 44 are preferably realized in the form of so-called opening contacts. The two switching contacts 43, 44 each are connected to the converter 38 via separate lines, or directly to the external interface 39 leading to the industrial machine control.

In the present embodiment, the receiving means 34 for receiving the connection of a suitable computer unit 1, such connection being releasable, if need be, and preferably without requiring tools, with the support body 33 of the expansion device 32, comprises the elastically yielding or elastically supported holding means 45, 46 for accommodating the housing 2 of the computer unit 1. Said holding means 45, 46 are formed within the area around the preferably recessed receiving means 34 on the support body 33. With the computer unit 1 in its inserted position, said holding means 45, 46 embrace or overlap part areas of the housing 2 of the computer device 1, and thus prevent said components from unintentionally getting detached from one another. Jointly with the holding means 45, 46 for holding the housing 2, the receiving means 34 also effects proper positioning of the interfaces 6, 7 of the computer unit 1 vis-à-vis the interfaces 35, 39 of the expansion device 32, so that a reliable signal or communicative connection is assured.

The holding means 45, 46, which are realized in the form of soft-elastic flaps, may be realized also in the form of the coupling elements 47, 48 that are provided for building up a mechanically secured, releasable connection between the expansion device 32 and a housing 2 of a computer unit 1 that can be associated with such a device 32. As an alternative to a connection system realized without tools by means of the coupling elements 47, 48 between the expansion device 32 and the housing 2 of a computer unit 1, it is naturally possible also to provide for screw connections between said components that can be serviced without or with the help of tools.

The interface 35 on the support body 33 of the expansion device 32 is preferably placed in a manner such that the proper insertion or association of a computer unit 1 versus the support body 33 via said interface 35 will automatically result in a build-up that is capable of functioning as a data or signal connection to a corresponding interface 6; 7 of a computer unit 1, or permit such a structure. In any case, the interface 35 represents the counterpiece to a standard-type interface 6, 7 on a suitable computer unit 1. Said interface 35 may be provided with contacts with a plurality of contact surfaces, on the one hand, so that it can be connected in an electrically conducting manner to a contact-equipped interface 7 of the computer unit 1. It is, of course, possible also to realize the interface 35 of the expansion device 32 in the form of a wireless interface with no contacts, particular as an infrared, radio or sound interface if the corresponding signal or data interface of the computer unit 1 is employing one of said physical data transmission systems.

The support body 33 substantially represents a soft-elastic or fracture-proof and thus protective cover 49 for the housing 2 of a mobile standard-type computer unit 1. Said cover 49, which is formed, for example from unbreakable plastic, encloses the computer unit 1 inserted therein mainly in its edge and corner areas, so that the computer unit 1 or its housing 2 is effectively protected against damage if the expansion device 32 including the computer unit 1 should drop to the floor due to carelessness. Said cover 49 therefore also represents a type of fracture-proof or damping shell for the computer unit 1 inserted therein, or for the relatively sensitive touch screen 12. The computer unit 1 is preferably arranged sunk versus the outer edges or outer surfaces of the support body 33 of the cover 49, or at least in a flush manner as shown mainly in FIG. 2.

In the embodiment according to FIGS. 2 and 3, the support body 33 has a substantially semicircular cross-section. In particular, the backside of the support body 33 is rounded in such a manner that the expansion device 32 can be comfortably and safely picked up and gripped by the hand of the user. The flattened front side of the support body 33 is forming the receiving means 34 for accommodating a substantially panel- or plate-like computer unit 1, said receiving means 34 being as plane as possible.

Good ergonomic properties of the expansion device 32 or of its support body 33 can be obtained also if the connection of the interface cable 40 on the expansion device 32 is arranged opposite the emergency OFF-switch 14 on the expansion device 32. In this connection, the interface cable 40 preferably adjoins an underside 50 of the support body 33, whereas the emergency OFF-switch 14 is preferably mounted on a topside 51 of the expansion device 32. The expansion device 32 or support body 33 are preferably designed in a manner such that the standard-type input devices 10 and display devices 8 are directly accessible or visible on the mobile computer unit 1 if the latter is associated with the expansion device 32 in order to be adapted for application in conjunction with industrial machine controls.

FIG. 4 shows a block diagram of a possible system configuration for technically effectively connecting a standard-type mobile computer unit 1 with an industrial machine control 32 via the described expansion device 32 for a standard-type computer unit 1 such as, e.g. a conventional PDA, handheld computer or the like. Identical reference numerals are used for the components described above, and the preceding descriptions are applicable in the same sense to identical components identified by identical reference numerals.

In the present embodiment, too, the module-like expansion device 32, which is designed as an independent structural unit for commercially available or known computer units 1, is equipped with at least one safety switch element 13. The expansion device 32 comprises at least one single-circuit or multi-circuit emergency OFF switch 14. Optionally, however, at least one approval key 15 may be formed on the expansion device 32, as indicated by dashed lines. Such approval keys 15 are basically required only if the system unit comprised of the expansion device 32 and the computer unit 1 is intended to be employed for triggering or monitoring functions or movements critical to safety, or such functions or movements are to be protected against unintentional activation.

Said optional expansion device 32, which can be coupled with or released from a standard-type computer unit 1, if need be, furthermore comprises an electronic controller and/or evaluator 53. Said controller and/or evaluator 53 may also form or comprise the converter 38 described above. Said controller and/or evaluator 53 preferably comprises a microcontroller 54 or some other electronic logic unit. In the present connection, said microcontroller 54 represents the central data processing or data management unit of the controller and/or evaluator 53 in the support body 33 of the expansion device 32.

The safety switches 13 formed on the expansion device 32 each are connected to the controller and/or evaluator 53 via at least one line 55. Via said line, the controller and/or evaluator 53 is capable of detecting at any time the actual switching or actuating state of the safety switch elements 13. Instead of so-called polling, it is naturally possible also for the safety switch elements 13 to actively transmit or report the given switching state to the controller and/or evaluator 53.

At least the given active conditions of the safety switch elements 13, i.e. at least those conditions occurring when the safety switch elements 13 are actuated or activated, are transmitted by the controller and/or evaluator 53 via the external interface 39 at least to the external industrial machine control to which the expansion device 32 has been switched to, functionally speaking. Said external machine control 52 subsequently has to convert the switching commands preset by the safety switch elements 13, i.e., with an activated emergency OFF switch 14 on the expansion device 32, the industrial machine control 52 of the controlled machine or plant will changed to a safe operating condition. On the other hand, if an optionally present approval key 15 is present and has been activated, the external machine control 52 will permit the execution or initiation of functions that are critical to the safety, but have been secured in this way. In this connection, as it is known per se, such approval keys 15 have to be used in combination with the actual operating elements of the machine control 52, which may be formed by the input device 10 on the standard-type computer unit; by operating elements on the expansion device 32; and/or by operating elements directly on the machine control 52, so as to be able to trigger the desired function or to permit the machine to be operated accordingly. In the normal case, such approval signals of the approval keys 15 thus act on the control circuit or on the electronic control of a technical plant or machine.

In the present exemplified embodiment, the desired signal or communication link between the expansion device 32 and the external machine control 52 takes place via the contact-equipped interface 39 and an interface cable 40 leading to a suitable communication interface 56 of the external machine control 52. The interface 39 of the expansion device 32 may be designed or suitable, for example for connection to a so-called Interbus, Profibus, CAN, DeviceNet, or Ethernet interface, or to some other standardized communication interface 56 of industrial machine controls 52. If necessary, the interface 39 may be provided also for connection to a customer-specific communication interface 56 with specially developed communication logs.

The other interface 35 of the expansion device 32 has to be provided for the data-technical or communicative connection to a conventional computer unit 1 in the form of an organizer or handheld PC that can be associated with the expansion device, if required. In the present embodiment, the interface 35 is formed by a contact-equipped interface comprising a plurality of the contact elements 57, via which an electrically conductive link can be established to a corresponding, standard-type interface 7 on the computer unit 1 for general application purposes. It is possible via said communication link 58 to transmit data unidirectionally or bidirectionally between the computer unit 1 and the controller and/or evaluator 53 of the expansion device 32. By interconnecting the controller and/or evaluator 53 of the expansion device 32, it is possible to exchange or to transmit process-relevant data or signals at least unidirectionally between the associated computer unit 1 and the external machine control 52 connected thereto. The controller and/or evaluator 53 may serve in this connection as a so-called interpreter or converter between a communication log tat is valid for the computer unit 1, and a communication log that is valid on the external machine control 52. Thus the signal or data transmission takes place via the interface 35, the controller and/or evaluator 53 and the interface 39 between the external machine control 52 and the generally known, standard-type computer unit 1.

It is therefore possible to transmit process-relevant data via said communication line to the computer unit 1 and to visualize such data, e.g. on the display device 8, particularly on the touch screen 12 of the computer unit 1. Alternatively or in combination therewith, it is possible to store or intermediately store process-relevant data of the external machine control 52, or the plant or machine controlled by the latter, in a storage device 59 of the expansion device 32 and/or in the storage devices 4 of the computer unit 1 (see FIG. 1). Likewise, if need be, it may be possible via said communication line described above to further transmit or to pass on defined data inputs or switching commands to the external industrial machine control 52, starting from the computer unit 1 or its software modules, in an automated manner and/or starting from the user by means of manual actuation of the input device 10.

Therefore, the controller 53 furthermore comprises at least one storage device 59 for storing system-relevant data and/or software-technical means. Said storage device 59 for intermediately storing and/or permanently storing data or software modules may be formed by independent, discrete components, or it may be partly integrated in the microcontroller 54 of the expansion device 32. In this connection, the discretely built-up storage device 59 is connected to the controller and/or evaluator 53, in particular to its microcontroller 54 via at least one line 60. The storage device 59 may be formed, e.g. by RAM, EEPROM or flash memory modules. Likewise, as explained already above, it is possible also to equip the expansion device 32 with exchangeable, replaceable storage modules in order to change programs and/or data in a simple manner, or to be able to transfer such program and/or data to other electronic dp equipment.

In the storage device 59 of the controller and/or evaluator 53, said device preferably being non-volatile, it is possible also to store there software-technical means, among other things, for adapting communication logs that are valid for the provided computer unit 1, to those communication logs that are required for a data transmission connection with the external industrial machine control.

Instead of evaluating the switching state of the safety switch elements 13 purely on hardware, it is possible also to make provision for storing in the control and/or evaluator 53 or its storage device 59 technical software means for detecting or evaluating in each case the actual actuation or switching state of the safety switch elements 13, and/or for transmitting to the external electronic machine control 52 information at least relating to the active actuation or switching state of the safety switch elements 13.

However, also personal data and/or person-related setting or profiles such as, for example user profiles or machine profiles may be stored in the controller and/or evaluator 53 or its storage device 59, which, when needed, can be transmitted to the external machine control 52, or at least output to the display device 8. Likewise, it is conceivable to store in the storage device 59 of the expansion device 32 system service routines, measuring and comparative data, user data, machine data, auxiliary documents, error lists, instruction lists and other data, which can be evaluated or visualized on the computer unit 1 and/or transmitted to the external machine control 52. Primarily the available storage and/or visualization capabilities of the general mobile computer unit 1 favor their utilization as quasi-personal, portable and compact data carriers for recording and reproducing data in conjunction with industrial machine controls. At least the user interface, which is comprised of the display and input devices 8, 10 of the standard computer unit 1, may be already extensively familiar in this connection to the user, so that the latter can quickly familiarize himself or herself with the handling and application in conjunction with industrial machines or plants. The universality of the computer unit 1 for private and/or business applications and now also for industrial application purposes may distinctly raise the efficiency of the system as defined by the invention as well. The intuitive man-machine interface or man-computer unit interface, to which users are accustomed to the greatest possible extent, will contribute just as much to the beneficial application of commercially available computer units 1 that basically can be carried long always.

The proposed expansion device 32 can be referred to also as a “docking station” or supplemental device or adapter for functionally linking a conventional, commercially available computer unit 1 with an industrial machine control 52, and said components result overall in beneficial operating and/or programming and/or monitoring device for industrial machine controls or machines or plant connected thereto.

FIG. 5 shows another embodiment of a compact and commercially available, mobile computer unit 1. Said computer unit 1 is applicable at least for the maintenance and/or diagnosis of external industrial machine controls 52. Identical reference numerals are used for components already described in the preceding text, and the preceding descriptions are applicable to identical components with the same reference numerals as well.

The communication system 61 shown in FIG. 5 disposed between an electronic machine control 52 that is available as a standard type of control, comprises a supplemental device 62 for communicatively or functionally connecting a general computer unit 1 to an electronic machine control 52 for technical plant systems or robots. Such a supplemental device 62 can be referred to also as a communication adapter or interface module between the computer unit and the machine control 52.

The supplemental device 62, which is preferably designed as an independent structure, comprises at least one communication interface 63 for connection to a corresponding interface 56 of the machine control 52 to which it is tied. The at least one communication interface 63 may be formed, for example by an Interbus-, Profibus-, CAN-, Device-Net-, Ethernet-, RS232-, USB-, Firewire- or some other standard interface of the industrial machine control 52 with which it is employed. The communication interface 63 of the supplemental device 62 is preferred connected to the corresponding communication interface 56 of the machine control 52 in an electrically conductive manner.

In addition to the communication interface 63 for connection to an industrial machine control 52, the supplemental device 62 comprises other interfaces, and at least one other communication interface 64; 65; 66 for communicatively linking it with a standard-type interface 6; 7 on a commercially available computer unit 1. Depending on the preferred communicative connection between the mobile computer unit 1 and the supplemental device 62, a communication interface 64 of the supplemental device 62 may be formed by a radio interface 67, for example according to the Bluetooth standard or the Wireless LAN or the GSM or the UMTS standards, or according to some other standard-type radio transmission system. In this connection, said radio interface 67 may communicate in terms of signal transmission technology with a corresponding radio interface of the computer unit 1 according to one of the standards specified above. Important is that the respective radio interface 64 of the supplemental device 62 is capable of being communicatively linked with a standard-type corresponding interface 6 on the computer unit 1. The radio interface 67 normally comprises an antenna or coil arrangement, as it is symbolically indicated in the drawing.

Alternatively or in combination with the above specification, provision can be made on the supplemental device 62 also for a communication interface 66 designed in the form of an infrared interface 68 that is capable of being communicatively linked with a corresponding interface 6, particularly with an infrared interface of the computer unit 1. Via a wireless signal or data transmission path 69 (see the double arrows), the respective signals or data then can be transmitted bi- or, if need be, also unidirectionally between the standard-type mobile computer unit 1 and the supplemental device 62 located near or on the locally stationary machine control 52. In this connection, the supplemental device 62 of the machine control 52 serves for intermediately storing and/or converting and/or processing and/or managing data or signals to be transmitted or exchanged between the standard-type computer unit 1 and the machine control 52.

Alternatively or in combination with the wireless communication interfaces 64, 66 described above, the communication interface 65 can be designed also as a contact interface 71 capable of being electrically connected to a corresponding, contact-equipped interface 7 of the standard computer unit 1 if the latter is associated with a supplemental device 62 or suitable positioned or placed on such a supplemental device 62. The supplemental device 62 thus may represent also a type of “docking station” or “parking” device for the computer unit 1, whereby the contact-equipped interface 71 and the corresponding interface 7 on the computer unit 1 are electrically conductively linked in their associated condition.

In this connection, one of the standard-type interfaces of the computer unit 1, particularly the interface 7, is provided with at least one safety switch element 13 for said connection. The safety switch elements 13 shown on both sides of the longitudinal edges of the housing 2 of the computer unit 1 are formed in this connection by the emergency OFF switches 14. Said safety switch elements 13 are formed in this connection in the edge zones 24, 26 of the housing 2 of the computer unit 1, said edge zones opposing one another. When the mobile computer unit 1 is held as intended, said edge zones 24, 26 opposing each other are at least partly seized all around, and the safety switch elements 13 are placed in this connection in a manner such that such elements are located within the immediate reach for the fingers of the hand that is simultaneously holding the computer unit 1 as well. In particular, the safety switch elements 13 may be arranged directly beneath those fingers that retain the housing 2 of the compact mobile computer unit 1. Due to the fact that the safety switch elements 13 are arranged opposing one another, particularly the emergency OFF switches 14, said safety switch elements 13 can be comfortably, reliably and immediately accessed when operated with either the left or the right hand. In particular, it is necessary only to increase the pressure exerted onto the computer unit 1 via the ball of the thumb and/or the fingers via a defined limit value for triggering or activating at least one of the safety switch elements 13, or at least one of the emergency OFF switches 14. The individual emergency OFF switches 14 on the computer unit 1 or its expansion device 32 may be functionally connected in series and line-connected with the respective input interface, particularly the interface 7 of the computer unit, as basically illustrated with the lines 72, 73.

As an alternative to or in combination with the emergency OFF switches 14, at least one approval key 14 may be designed also as an additional safety switch element 13. As described already above, particularly a multi-stage safety switch element 13 is specially well-suited for this purpose in the present embodiment and arrangement of the safety switch elements 13. In the present embodiment of the computer unit 1 or its expansion device 32, a support body 74 for the safety switch elements 13 is placed around the housing 2 of the standard computer unit 1 in the form of a clamp or clip. Said support body 74 can be snapped or slipped on without requiring tools and/or secured in this connection on the housing 2 of the computer unit 1 with the help of fasteners such as, e.g. screws. The safety switch elements 13 formed in or on the support body 74 are internally linked or wired and lead outputs of the safety switch elements 13 integrated therein or mounted thereon directly to a suitable input, e.g. via the lines 72, 73, particularly to the standard interface 7 of the computer unit 1, as clearly shown in FIG. 5. Technical software means that the processor unit 3 of the computer unit 1 is capable of processing or executing can then be stored in the storage device 4 of the computer unit 1. Such technical software means serve for detecting and evaluating the given switching or actuation state of the external safety switch elements 13 on the housing 2 of the computer unit 1. In addition, the technical software means in the computer unit 1 can serve for transmitting or making available information at least in regard to the active state of the respective safety switch elements 13, to an external machine control 52 linked with the computer unit 1.

In the storage device 4 of the computer unit 1, it is possible also to store technical software means for functionally tying the standard-type computer unit 1 to an external industrial machine control 52 in terms of data transmission technology. Moreover, technical software means can be fetched from the storage device 4, such software means being provided for utilizing the arithmetic capacity of the external machine control 52 in conjunction with the processor unit 3 of the computer unit 1. The technical software means stored in the storage device 4 of the computer unit 1 primarily also serve the purpose of permitting the display capacity of the display device 8 to be used in conjunction with the external industrial machine control 52. Likewise, the technical software means stored in the storage device 4 are suited for allowing the input capacity of the input devices 10 formed in the standard computer unit 1 to be utilized in conjunction with the external machine control 52. Other technical software means in the storage device 4 may function as interpreters for adapting a communication log valid for the computer unit 1, to a communication log that may be different and required for the external machine control 52. Therefore, overall, the technical software means stored in the storage device 4 are provided for the purpose, among others, of permitting the generally known standard-type computer unit 1 to be utilized as an operating and/or display device 75 for an industrial machine control 52 that can be tied to the latter, if necessary, or to the technical plants, machines or robots etc. that are connected to such a machine control.

However, the technical software means available in the storage device 4 may also render the computer unit 1 suitable for applying it as a programming device 76 for functions or sequences of operation of the machine control 52 or of the machine to be controlled.

However, the storage device 4 of the computer unit 1 can be utilized also as a key for user identification or authorization control and for releasing it versus the machine control 52, if need be. But the computer unit 1 or its storage device 4 can be utilized also as a portable storage medium for storing personal user profiles and machine data, as well as for accessing documents based on text and/or graphics and stored in the storage device 4 of the computer unit 1. The other data access capacity of the computer unit 1 such as, e.g. the possibility for tying it to global or locally restricted data networks, e.g. Internet, WAP or the like, can be used via the computer unit 1 just as well, and may be helpful in conjunction with the machine control 52 to a user, programmer or service technician of machines or technical plants. In particular, operating, programming or maintenance personnel can be supported in their required programming, maintenance, monitoring or diagnostic work on the machine control 52 via the computer unit 1 adapted as defined by the invention. For example, operating instructions, error elimination lists, pointer lists and the like can be locally called in from the storage device 4 via the computer unit 1, and/or fetched therefrom via the standard remote access capability and transmitted to other external data sources or visualized, and subsequently utilized in conjunction with the external machine control 52. It is likewise conceivable to unload via the remote data access of the general computer unit 1 programs or data from an external memory, and to load the latter via the described signal or data transmission path 69 either directly or following prior adaptation in the industrial machine control 52.

It is important that the mobile, standard-type computer unit 1 as defined by way of example by the embodiment according to FIG. 5 comprises only one coupling in terms of signal or data transmission technology to an external machine control 52 or supplemental device 62, and that no direct mechanical or physical link exists between the computer unit 1 and the supplemental module or supplemental device 62 wirelessly communicating therewith.

Instead of forming a structurally independent supplemental device 62, it is naturally possible also to integrate the latter or its components in the machine control 53. If the supplemental device 62 is designed as a separate stationary module in the communication system 61 and intended for the wireless transmission and/or reception of signals or date vis-á-vis as remote mobile computer unit 1, said supplemental device 62 is preferably placed in an exposed position within the vicinity of the plant equipment or machine to be controlled that is favorable for the reception. This is one of the preconditions for obtaining a counter position versus the mobile and highly standardized computer unit 1 that can be widely and safely reached.

The supplemental device 62 itself can be coupled on its communication interface 63 to a suitable communication interface 56 of the machine control 52 preferably via an electrical or optical cable connection 70.

So as to achieve with the wireless communication system 61 described above, the latter being comprised of the computer unit 1 and the supplemental device 62 functioning as the counter component, the safest possible data transmission connection within the signal or data transmission path 69, at least some of the measures described in the following have to be implemented.

First, a distinctly associated or targeted connection has to be established between the computer unit 1 and the machine control 52 or counter position on the control side, or supplemental device 62, that is secured as much as possible with respect to unintended communication interruptions. With such assignment or logon, precautions have to be taken that will assure that the user of the mobile computer unit 1 will establish the connection consciously and with exactly each machine or machine control 52 that he wishes to operate, monitor and/or program in terms of dp technology. Such safe logon or allocation methods have been proposed by the present Applicant already earlier.

In addition, it is necessary to continually monitor whether the locally distant computer unit 1 with the allocated safety switch elements 13 is reporting a unchanged safe condition, or whether such a condition is present. The supplemental device 62 or the machine control 52 itself thus has to monitor the presence of a safe operating condition. Alternatively, however, also other switching commands or individual safety-relevant status messages can be actively transmitted to the machine control 52, starting from the computer unit 1, and have to be converted by the latter as quickly as possible accordingly. If one of the safety switch elements 13, particularly one of the emergency OFF switches 14 characterizes or reports an activation, actuation or any change in the switching state, or if the state of connection between the mobile computer unit 1 with the safety switch elements 13 and the supplemental device 62 on the control side is no longer secured, or if errors, manipulations or interference are detected in the data packets received, the respective machine or plant equipment so affected is changed to a safe operating condition. Such a safe operating condition can be initiated either by the supplemental device 62, or implemented by the machine control 52 via passing on the information or signals to such machine control connected to the supplemental device 62.

Also, a so-called “watchdog” may be implemented in terms of software or hardware technology in the computer unit 1 and/or the supplemental device 62, or directly in the machine control 52, by which the state of connection between the computer unit 1 and the machine control 52 or the allocated supplemental device 62 is monitored.

Heightened safety in the data connection between the mobile computer unit 1 and the machine control 52 wirelessly linked therewith, can be obtained also by securing the data telegrams with the signaling state of the safety switch elements 13. For example, simple check sums can be formed; time information can be evaluated, and/or codes or signatures can be defined for the safety switch elements 13 and/or transmission channels and/or for the input elements of the input device 10. The switching state “safe” or “unsafe” of the safety switch elements 13 can be transmitted logically to the supplemental device 62 or machine control 52 on a single channel, or, for increasing the transmission or data safety, also on multiple channels via the wireless signal or data transmission path 69. Such multi-channel or multi-circuit transmission of the signal information of the safety switch elements 13 may take place also in parallel via different transmission media such as, e.g. radio and infrared. Furthermore, different transmission channels can be defined within a transmission media so as to be able to raise the safety and reliability of the connection or data transmission.

The various switching conditions of the different safety switch elements 13 and/or other operating elements on the input device 10 can be transmitted jointly in a safety telegram, or also individually or combined in groups, in order to achieve an ordered and safe communication connection.

It is important that the given switching state of the safety switch elements 13 or general operating elements of the input device 10 on the computer unit 1 are transmitted wirelessly at regular time intervals to the supplemental device 62, or directly to machine control 52. When using bidirectional communication channels within the signal or data transmission path 69, additional test and safety data such as, for example time information or random keys, can be first transmitted by the later receiver of the process-relevant to the mobile computer unit 1, and built by the latter into the signal telegrams to be transmitted. However, a highly safe wireless transmission of the given operating or signal conditions may take place also through a multi-circuit or multi-channel transmission and/or several processors with crosswise comparison of the result. In particular, provision has to be made in this connection for two processors operating independently of one another in each of the supplemental device 62 and the computer unit 1 or expansion device 32, whereby each pair of processors is provided for one transmission channels, or allocated to one of the transmission channels in each case. Different evaluation results of the two processors in the supplemental device 62 or machine control 52 after the signals or data have been transmitted permit inferring transmission errors. If required, the machine or machine control 52 may thereupon, or following another transmission attempt, changed to the safe state and/or an alert may be issued first in order to avoid critical situations due to connection problems.

By making provision for redundancy in connection with technical software and/or hardware means both on the receiver and the transmitter sides of the transmission channel for signals or data, it is possible to achieve a so-called single-error safety and the functional safety of the entire system can be distinctly raised.

It was found to be useful to design the supplemental device 62 as a type of expansion module such as, e.g. in the form of an IO-module or plug in card, and to render it combinable or expandable with an industrial machine control 52 in this manner.

FIG. 6 shows another embodiment of an expansion device 32 as defined by the invention, for standard PDA's or conventional handheld PC's or organizers. Again, identical reference numerals are used for identical parts already described above, and the preceding descriptions are applicable in the same sense to identical components with the same reference numerals.

Said expansion device 32 is substantially identical with a so-called manual operating device or hand-held terminal for operating and/or programming and/or monitoring the execution of routines or functions of machine controls or robots.

With the present embodiment, a housing 78 of said manual terminal 77 rests on, e.g. the lower arm of a user, or said manual terminal 77 can be held with one hand and, if need be, additionally supported on the lower arm, as schematically indicated in the figure.

It is important in this connection that primarily the display and/or input capabilities of a standard-type computer unit 1 are utilized for the industrial manual terminal 77. In particular, the present embodiment is advantageous in that the standard-type touch screen 12 of the computer unit 1 is used for visualization and/or input functions of the manual terminal 77. Predominantly the graphical capabilities of the standard computer unit 1 are utilized depending on whether said manual terminal 77 is predominantly employed as a monitoring and visualizing device. If the manual terminal 77, in addition to monitoring and display functions, is expected to execute input and operating or controlling functions for industrial machine control systems as well, individual standard-type input devices 10 of the computer unit 1 such as, e.g. its keys; in particular, however, the touch screen 12 can be utilized for such purposes.

If necessary, at least some of the input elements 79 normally provided on manual terminals 77 of this type, are formed on the housing 78 of the expansion device 32 for the standard-type computer unit 1, and employable in conjunction with an external machine control system. The standard-type input elements 79 of the so-called manuals terminals 77 are defined by a plurality of keys 80, which are preferably designed in the form of a type of a so-called foil keyboard 81. With the individual keys 80 on the expansion device 32, it is possible to initiate and stop, e.g. different operating modes and/or various machine functions, and/or input data; and to navigate a machine control in the functional menu of the computer unit 1 and/or a machine control linked therewith.

Furthermore, a special input element 79 is preferably mounted on the housing 78 of the manual terminal 77 or the expansion device 32 as defined by the invention, such input element being specially suited for presetting movement sequences of machines or robots.

Such input elements 79 for controlling movements may be formed, e.g. by a so-called joystick 82; by a track ball, or by a force- and/or deflection-proportional control element or the like. Alternatively to the above or in combination therewith, it is possible also to utilize the touch screen 12 of the computer unit 1 as an input means for controlling the movements and functions of machines or robots.

The information or switching commands input via the input elements 79 of the expansion device 32 can be passed on to the external machine control either directly or indirectly with interconnection of the computer unit 1. For said purpose, a suitable electronic controller may be arranged within the expansion device 32 or the converter 38, which detects the signals or switching commands made available by the input elements 79 and transmits such signals or commands to the computer unit 1 via at least one line 1, and/or via the interface 39 of the expansion device 32 directly to an external machine control as schematically shown in the figure. Instead of forming an interconnected electronic converter 38 for the switching commands, it is naturally possible also to make available some of the switching information of the input elements 79 directly on the interface 39 of the expansion device 32, or to keep such information available there.

For the purpose of creating a visual possibility for controlling the inputs effected by means of the input elements 79, the respective switching commands or the actions initiated therefrom via the interface 35 can be transmitted also to the standard computer unit 1 and visualized by the latter, or processed in some other way. In this connection, the information or switching commands of the individual input elements 79 can be transmitted via the interface 35 and directly supplied to the contact-equipped interface 7 of the computer unit 1. Alternatively thereto or in combination therewith, it is possible also to transmit such information from the input elements 79 of the expansion device 32 to the computer unit 1 via a wireless interface 6 of the latter. Said wireless interface 6 of the computer unit 1 may be formed, for example by an infrared interface 84 of the computer unit 1, said interface being available as standard equipment. For this purpose, the expansion device 32 comprises an infrared interface 85 corresponding with the infrared interface 84 of the standard-type computer device 1. Data or signals of the input elements 79 on the expansion device 32 can be transmitted wireless and without contact to the allotted or receiving computer unit 1. The infrared interface 85 of the expansion device 32 is placed in this connection in a manner such that it is capable of communicatively connecting with the infrared interface 84 of the computer unit 1 when a suitable computer unit 1 is properly inserted in the expansion device 32 or placed on the latter. In the exemplified embodiment shown, the computer unit 1 can be inserted in a recessed receiving trough 34 formed on the support body 33 of the expansion device 32. The comparatively sensitive standard-type computer unit 1 is effectively protected against damage in this way. The recessed receiving trough 34 protects individual components of the standard computer unit 1 against excessive force, scratches and the like. Particularly if the expansion device 32 with the standard-type computer unit 1 inserted therein should be dropped to the floor, the input elements 10 and/or the touch screen 12 of the computer unit 1 are effectively protected against damage when hitting the floor. Furthermore, the to some extent impact-damping effect of the support body 33 enclosing the computer unit 1 offers superior protection for the computer unit 1 against higher stress.

The standard-type computer unit 1 can be simply inserted in or removed from the receiving trough 34 with the help of the holding means 45, 46. Such holding means 45, 46 are preferably arranged in the edge zone of the receiving trough 34 for accommodating the housing 2 of the computer unit 1. The shape of the receiving trough 34 conforms to the greatest possible extent to the outer contour of the housing 2 of the computer unit 1, so that the housing can be inserted therein the relatively high accuracy of its position, and at least one interface 6, 7, or the infrared interface 84 of the computer unit 1 is capable of appropriately establishing a communicative connection with the at least one corresponding interface 35 or infrared interface 32, respectively on the expansion device 32. The theoretical possibility for establishing a connection between the interfaces 6, 7 of the computer unit and the allocated interfaces 35; 85 is preferably automatically realized by allocating the computer unit 1 to the expansion device 32 without having to make connections such as, e.g. plug connections separately by hand. A definite communicative connection via the prepared communication path can be built up, for example by key pressure or, if need also, fully automatically in the way of a “plug and play” connection.

It is important in connection with the present embodiment, furthermore, that the optional expansion device 32 for the standard-type computer unit 1 has a cable-bound interface 39 leading to an external industrial machine control system. In particular, provision is made for an interface cable 40 between the expansion device 32 or the manual terminal 77 and the correspondingly allocated mobile computer unit and a conventional external machine control. In the present embodiment, the safety switch elements 13 formed or mounted on the expansion device 32 are directly wired to a connected industrial machine control via the cable-bound interface 39, which means that the at least one safety switch element 13 on the expansion device 32 is directly wired to the machine control, or directly connected to the latter via a cable. In particular, at least one line 86 is directly leading to the interface 39, starting from at least one of the safety switch elements 13, particularly from an emergency OFF switch 14 on the expansion device 32, and is subsequently directly connected via the interface cable 40 to a corresponding safety circuit or safety circuit input of the external industrial machine control. This means that the safety switch element 13, but primarily, however, an emergency OFF switch 14 on the expansion device 32 is wired or hard-wired directly to the machine control via the interface cable 40 of the expansion device 32. Owing to such direct wiring of the safety switch element 13, primarily of the emergency OFF switch 14 to the external industrial machine control, high functional safety or functional reliability of the safety switch element 13 is achieved with a relatively simple constructional design of the corresponding manual terminal 77. In particular, in a serious case of emergency or panic situation, the intended functions of the emergency OO switch 14, which is usually actuated abruptly when such a case occurs, will still be effective with high reliability. The emergency OFF switch 14 may usually directly act on the energy circuit of a technical plant or machine via the lines 86, and in this way puts such a plant or machine in a safe operating condition or the defined NO-STOP state.

If necessary, the expansion device 32 as defined by the invention for the mobile computer unit 1, or the corresponding manual terminal 77, may comprise at least one approval key 15 as an additional safety switch element 13. In this connection, The switching information of such at least one approval key 15 again may be detected via the mobile computer unit 1 employed, or the converter 38 of the expansion device 32, and supplied to the external machine control. In the exemplified embodiment shown, said approval keys 15 are directly connected to the interface 39 of the expansion device 32 via at least one line connection 87, whereby said interface 39 is directly leading to the industrial machine control where operating or monitoring functions are to be executed. This means that the approval keys 15 as well may be hard-wired to a corresponding input of the external machine control via the expansion device 32 or the manual terminal 77 with the employed standard-type computer unit 1. Most of all, using a combined multi-stage safety switch element 3 with an approval and emergency OFF function permits the wiring via the lines 86 or the line connection 87 to be simplified.

As shown schematically, the interface 35 of the expansion device 32 leading to the computer unit 1 is realized in the form of a contact-equipped interface 35, and individual electrical lines are provided between the contact surfaces of said interface 35 and the external interface 39 for connecting the expansion device 32 to an external machine control. In particular, individual conductors of the interface cable 40 may exit within the area of the interface 39, and directly lead to the contact surfaces of the interface 35 in order to be able to produce a corresponding communication or signal connection with an allocated mobile computer unit 1, as it is schematically shown. This means that via the interface cable 40, both the switching information or switching commands of the directly wired safety switch elements 13 and the signals or data can be transmitted or exchanged between the external machine control and the computer unit 1.

FIG. 7 shows yet another embodiment of the expansion device 32 as defined by the invention for a standard-type mobile computer unit 1. A beneficial modification of a per-se known manual terminal 77 for operating and/or monitoring and/or programming industrial machine controls is contained in said embodiment as well. Again, identical reference numerals are used for identical components already described in the preceding specification, and the preceding descriptions are applicable to identical components with identical reference numerals in the same sense as well.

It is of importance in connection with said embodiment that a standard-type wireless interface 6, particularly a radio interface 88 of the standard computer unit 1, particularly a commercially available PDA, handheld computer or the like, for transmitting and/or receiving signals or data between the expansion device 32 and an external industrial machine control, is employed. In particular, signals or data can be exchanged between the computer unit 1 or expansion device 32 and the external industrial machine control via said standard-type radio interface 88 of the mobile, compact computer unit 1. Most important of all, via the radio interface 88, it is possible to transmit switching signals or input data from the various input elements 79 of the expansion device 32 to the machine control 52 in order for such signals or data to be evaluated and converted by said control. Likewise, process-relevant signals or information can be received by the computer unit 1 by means of the radio interface 88, starting from the external industrial machine control, and evaluated and visualized by the components of the expansion device provided for such functions. Furthermore, signals or data received can be visualized via the display device 8, and/or process-relevant signals or data can be stored in the standard-type storage devices of the computer unit 1.

Therefore, if necessary, at least one wireless data transmission path 89, 90 can be built up between the external machine control or a supplemental device 62 (FIG. 5) allocated to said control and described in the preceding text of the present specification, and the standard mobile computer unit 1. It is important that the available functional capability of the computer unit 1 for transmitting and/or receiving data via radio signals is utilized for transmitting and exchanging process-relevant data within the communication system 61 between the machine control and the expansion device 32 or computer unit 1. The radio interface 88 of the computer unit 1 normally comprises an accordingly conceived antenna or coil arrangement as symbolically indicated in the figure.

In light of the fact that said embodiment of the optional or modular expansion device 32 for a standard-type computer unit 1 has been entirely designed without using cables, and the relevant signals or data are transmitted and received exclusively wirelessly via the radio interface 88, a preferably self-supporting energy supply device 91, the latter being independent of any supply mains, is formed on the expansion device 32. Said energy supply 91 is formed by the electrochemical voltage sources 92, particularly by at least one accumulator or at least one battery. The energy supply device 91 in the support body 33 of the expansion device 32 preferably supports the energy supply integrated in the standard-type computer unit 1. This means that the capacity and useful life of the entire expansion device 32, including the computer unit 1, can be increased and prolonged, respectively, by means of said additional energy supply device 91 in or on the expansion device 32. Most importantly, if the radio interfaces 88 of the computer unit 1 are utilized, it is possible to achieve via said additional energy supply device 91 a longer service life or applicability of the entire expansion device 32, or of the functions of the computer device 1. The energy supply device 91 of the expansion device 32 is preferably connectable or connected to a corresponding energy supply input of the standard-type computer unit 1 via at least one line connection 93, 94. In the exemplified embodiment shown, the energy supply device 91 of the expansion device 3 is line-connected to the standard-type external energy supply connection of the computer unit 1 at its interface 7. However, the external energy supply connection of the mobile computer unit 1 can be formed also by an independent interface or socket on the housing 2 of the computer unit.

The energy supply device 91, particularly the at least one electrochemical voltage source 92, is preferably replaceably arranged in the support body 33 of the expansion device 32. If necessary, the support body 33 of the expansion device 32 may also comprise a connecting device for connecting it to a mains unit and for charging the energy supply device 91, particularly the voltage sources 92 realized in the form of accumulators.

The signals or information about the switching state of the safety switch element 13 on the expansion device 32 are transmitted to the computer unit 1 either directly or with interconnection of the electronic converter 38, and then transmitted by the latter to an industrial machine control via the radio interface 88. Feeding of the switching state information of the safety switch elements 13 to the mobile, standard-type computer unit 1 takes place via at least one of the interfaces 6, 7 representing standard features on the computer unit 1. In particular, said information or data can be transmitted to the computer unit 1 via the infrared interfaces 84, 85, and/or via the contact-equipped interfaces 35; 7 in the computer unit 1. The lines 83 leading to the interface 35; 7 and/or to the optical transmission unit of the infrared interface 85 are provided for said purpose. In the present exemplified embodiment, all information generated by the safety switch elements 13, particularly the at least one emergency OFF switch 14 and/or the at least one approval key 15, is supplied to the standard-type, mobile computer unit 1 via the electronic converter 38 of the expansion device 32. Said data are intermediately stored and/or processed by the computer unit 1, and subsequently transmitted via the radio interface 88 to the machine control of the corresponding machine or robot. Other switching and control commands entered via the input elements 79 of the manual terminal 77 are transmitted to the machine control by this way as well, and are then evaluated or converted by the latter accordingly.

The interface 6 or radio interface 88 of the standard-type computer unit 1 may be formed, for example by a Wireless-, LAN-, Bluetooth-, GSM-, or UMTS interface.

The present embodiment substantially represents a wireless manual terminal 77 whose data transmission connection to an external machine control is realized via the data or signal transmission function inherently available in the computer unit 1 or the general PDA or handheld computer. In this connection, the information of the supplemental elements on the expansion device, particularly of the safety switch elements 13 and of the general input elements 79, are wirelessly supplied to the external industrial machine control via the radio interface 88 of the standard-type computer unit 1, e.g. the PDA or handheld computer.

If required, the expansion device 32 may also comprise at least one transmitting and/or receiving antenna 95, 96 so as to be able to increase or enhance the transmitting and/or receiving power of the standard-type computer unit 1 in conjunction with the expansion device 32. With the computer unit 1 with the transmitting and/or receiving unit inserted in the support body 33 and correctly allocated to the latter, said additional transmitting and/or receiving aerials 95, 96 on the expansion device 32 are actively communicating with the transmitting and/or receiving unit, particularly with the radio interface 88 of the computer unit 1. Said additional transmitting and/or receiving aerials 95, 96 or separate amplifier circuits for the radio signals decisively improve the efficiency or functional safety of the wireless data transmission between the expansion device 32 or computer unit 1 and an external machine control or the supplemental radio unit 62 allocated to said control (FIG. 5).

If need be, provision may be made for mechanical adapter as well, which permit allocating different computer units 1 to a defined expansion device 32 or a defined support body 33. In particular, it is possible with such adapters to functionally allocate standard-type computer units 1 of different manufacturers, which usually have different dimensions or housing shapes, to the expansion device 32.

For the sake of good order it is finally pointed out that in the interest of superior appreciation of the structure of the mobile computer unit 1 or the expansion device 32, the latter devices or their components are partly represented herein untrue to scale and/or enlarged and/or reduced to some extent.

The problems forming the basis of independent inventive solutions can be derived from the specification.

Most importantly of all, the embodiments shown by way of example in FIGS. 1; 2, 3; 4; 5; 6; 7 may form the objects of independent solutions as defined by the invention. The relevant problems and solutions as defined by the invention can be derived from the detailed descriptions of said figures.

### List of Reference Numerals

1 Computer unit
2 Housing
3 Processor unit
4 Storage device
5 Storage medium
6 Interface
7 Interface
8 Display device
9 Top side
10 Input device
11 Key
12 Touch screen
13 Safety switch element
14 Emergency OFF switch
15 Approval key
16 Actuation element
17 Finger trough
18 Line
19 Line
20 Input
21 Input
22 Actuation element
23 Edge zone
24 Edge zone
25 Edge zone
26 Edge zone
27 Direction of actuation
28 Breakthrough
29 Breakthrough
30 Membrane
31 Membrane
32 Expansion device
33 Support body
34 Receiving means
35 Interface
36 Connection
37 Connection
38 Converter
39 Interface
40 Interface cable
41 Plug or screw connection
42 Contact block
43 Switching contact
44 Switching contact
45 Holding means
46 Holding means
47 Coupling element
48 Coupling element
49 Cover
50 Bottom side
51 Top side
52 Machine control
53 Controller and/or evaluator
54 Microcontroller
55 Line
56 Communication interface
57 Contact element
58 Communication connection
59 Storage device
60 Line
61 Communication system
62 Supplemental device
63 Communication interface
64 Communication interface
65 Communication interface
66 Communication interface
67 Radio interface
68 Infrared interface
69 Signal or data transmission path
70 Cable connection
71 Contact interface
72 Line
73 Line
74 Support body
75 Operating and/or display device
76 Programming device
77 Manual terminal
78 Housing
79 Input element
80 Key
81 Foil-type keyboard
82 Joystick
83 Line
84 Infrared interface
85 Infrared interface
86 Line
87 Line connection
88 Radio interface
89 Data transmission path
90 Data transmission path
91 Energy supply device
92 Voltage source
93 Line connection
94 Line connection
95 Transmitting and/or receiving aerial
96 Transmitting and/or receiving aerial

1. A mobile electronic computer unit (1) adapted to be held in one hand, particularly of the type of a so-called personal data assistant (PDA) or handheld computer, comprising a software-controlled processor unit (3); at least one storage device (4) connected to said processor unit for storing software modules and/or data to be processed; at least one display device (8) for the visually detectable output of information; and at least one input device (10) for at least influencing the operational functions of the computer unit (1) and/or for inputting data, whereby the display and input device (8, 10) preferably of the type of a screen sensitive to touch, for example in the form of a touch screen (12), are structurally superposing one another or are functionally combined; and with at least one interface (6; 7) of the standard type formed on the housing (2) of the computer unit (1), said interface being adapted to communicate with peripheral electronic or electric devices such as, for example a personal computer, wherein said standard-type interface (6; 7) and an independently designed interface are provided for being connected with at least one safety switch element (13) of the type of an emergency OFF-switch (14) and/or an approval key (15).

2. The mobile computer unit according to claim 1, wherein technical software means processible in the storage device (4) by the processor unit (3), are stored for detecting and evaluating the given actual actuation or switching state of at least one safety switch element (3).

3. The mobile computer unit according to claim 1, wherein technical software means processible in the storage device (4) by the processor unit (3), are stored for transmitting or supplying to an external electronic machine control (52) via the standard-type interface (6; 7) information about the active or inactive actuation or switching state of at least one safety switch element (13).

4. The mobile computer unit according to claim 1, wherein technical software means are stored in the storage device (4) for functionally and data-technologically connecting the processor unit (3) and/or the input device (10) and/or the display device (8) to a standard-type communication interface (56) of an external industrial machine control (52).

5. The mobile computer unit according to claim 1, wherein technical soft-ware means are stored in the storage device (4) for utilizing the computing capacity of an externally connected, per-se independently functioning machine control (52) in conjunction with the processor unit (3).

6. The mobile computer unit according to claim 1, wherein technical software means are stored in the storage device (4) for utilizing the display capabilities of the display device (8) in combination with an external industrial machine control (52).

7. The mobile computer unit according to claim 1, wherein technical software means are stored in the storage device (4) for utilizing the input capabilities of the input device (10) in conjunction with an external industrial machine control (52).

8. The mobile computer unit according to claim 1, wherein technical software means are stored in the storage device (4) for forming a converter for converting or adapting a communication log provided on the interface (6; 7) as a standard feature, into/to a communication log valid on the communication interface (56) of an industrial machine control (52) to be connected, and/or vice-versa.

9. The mobile computer unit according to claim 1, wherein technical software means are stored in the storage device (4) for utilizing the computer unit (1) as an operating and/or display device (75) connectable to the external machine control (52), or to a machine or plant controlled therewith as required.

10. The mobile computer unit according to claim 1, wherein technical software means are stored in the storage device (4) for utilizing the computer unit (1) as a programming device (76) temporarily connectable to the external machine control (52) for functions or operational sequences of the machine control (52) or a machine or plant controlled therewith.

11. The mobile computer unit according to claim 1, wherein technical software means and/or technical hardware means are stored in the storage device (4) for transmitting and/or receiving data or signals with heightened functional safety and reliability versus an external industrial machine control (52).

12. The mobile computer unit according to claim 1, wherein personal data and/or person-related adjustments, in particular user profiles are stored in the storage device (4) and, if need be, selectable therefrom, such data and adjustments and user profiles defining the properties or pre-settings of the computer unit (1) itself and/or of an industrial machine control (52) connectable to said storage device.

13. Application of a commercially available electronic computer unit (1) adapted to be held in one hand for operating and/or monitoring and/or programming operational sequences or conditions of per-se independently functioning industrial machine controls (52) and/or a machine or plant controlled therewith.

14. The application of a commercially available electronic computer unit (1) adapted to be held in one hand according to claim 1, for maintaining and/or diagnosing technical operational sequences or conditions of per-se independently functioning industrial machine controls (52) and/or of a machine or plant controlled therewith.

15. An expansion device (32) adapted for coupling it as required with a commercially available electronic computer unit (1) portable in one hand, comprising a frame- and housing-like support body (33) and a receiving means (34) on said support body, for loosely allocating the latter to or mechanically connecting it with a computer unit (1), as well as an interface (35) for producing a signal or data transmission link with said computer unit (1), whereby said interface (35) available on the side of said support body is provided for connection to an interface (6; 7) available on the computer unit (1) as a standard feature, wherein at least one safety switch element (13) of the type of an emergency OFF switch (14) and/or an approval key (15) are formed on the support body (33) for the secured execution, initiation, termination or monitoring of functions or operational sequences of industrial machine controls (52) and/or of a machine or plant controlled therewith, such functions or sequences being critical to safety.

16. The expansion device according to claim 15, wherein outputs or connections of the manually activated safety switch element (13) are directly and/or indirectly connected via an electronic converter (38) to the interface (35) linking said safety element with the computer unit (1), the latter being adapted to be accommodated or allocated as required, and/or to an interface (39) leading to an external industrial machine control (52).

17. The expansion device according to claim 15, wherein one single interface (35; 39) is formed on the support body (33) for actively linking an allocated computer unit (1) and the safety switch element (13) with an external electronic machine control (52).

18. The expansion device according to claim 15, wherein the interface (35) leading to an allocable mobile computer unit (1), and an interface (39) leading to an external machine control (52) to be linked with said computer unit, are technologically identical.

19. The expansion device according to claim 15, wherein an interface (6) between the safety switch element (13) and a mobile computer unit (1) adapted to be allocable thereto as required, is formed by a wireless interface, in particular an infrared interface (85) and a radio signal interface.

20. The expansion device according to claim 15, wherein the size of the receiving means (34) on the support body (33) approximately conforms to the size of the housing (2) of a computer unit (1) to be coupled therewith.

21. The expansion device according to claim 15, wherein in the receiving means (34) or within the area around said receiving means (34), provision is made for at least one holding means (45, 46), particularly for at least one coupling means (47, 48) for producing a mechanically secured and releasable, if need be, connection between the support body (33) and a computer unit (1) intended to be assigned thereto.

22. The expansion device according to claim 15, wherein the interface (35; 39) on the support body (33) is placed in a manner such that inserting or allocating a computer unit (1) intended for such insertion or allocation will automatically functionally set up a data or signal transmission link with the safety switch element (13) and/or an external industrial machine control (52).

23. The expansion device according to claim 15, wherein an electronic controller and/or evaluator (53) or at least one electronic converter (38) is formed for functionally linking an allocated computer unit (1) with an external industrial machine control (52).

24. The expansion device according to claim 23, wherein technical software means for adapting or interfacing communication logs of the allocated computer unit (1) and/or communication logs of the external industrial machine control (52), are stored in the controller and/or evaluator (53).

25. The expansion device according to claim 15, wherein a controller and/or evaluator (53) are integrated in or secured on the support body (33), and that technical software means are stored in a storage device (59) of the controller and/or evaluator (53) for detecting and evaluating the given actual switching or actuation state of the safety switch element (13), and for transmitting or supplying information pertaining to the active or inactive switching or actuation status at least of the safety switch element (13), to an external electronic machine control (52).

26. The expansion device according to claim 23, wherein the controller and/or evaluator (53) has technical software and/or hardware means for transmitting and/or receiving data or signals with heightened functional safety or reliability vis-à-vis an external industrial machine control (52).

27. The expansion device according to claim 23, wherein the controller and/or evaluator (53) is designed for transmitting personal data or person-related identifications to an external industrial machine control (52).

28. The expansion device according to claim 23, wherein individual adjustments or user profiles for an allocated computer unit (1) and/or a connectable external machine control (52) can be storable in, retrievable from and/or changeable in the control and/or evaluator (53).

29. The expansion device according to claim 15, wherein at least one input element (79) such as, e.g. a key (80), a switch, a proportional control element, a potentiometer or the like are formed on the support body (33).

30. The expansion device according to claim 15, wherein at least one movement control element such as, e.g. a joystick (82) or a track ball or the like is formed on the support body (33).

31. The expansion device according to claim 15, wherein the support body (33) is realized in the form of a softly elastic or shock-absorbing cover for a mobile computer unit (1) mechanically connectable therewith.

32. The expansion device according to claim 15, wherein the support body (33) at least partly encloses the edge and corner zones of a housing (2) of a computer unit (1) allocated to and inserted in the receiving means (34) of said support body accommodating said housing.

33. The expansion device according to claim 15, wherein an energy supply device (91) formed by electrochemical voltage sources (92) is formed independently of an energy supply mains network.

34. The expansion device according to claim 33, wherein the energy supply device (91) is formed by batteries replaceably receivable in the support body (33).

35. The expansion device according to claim 15, wherein the interface (39) leading to an external industrial machine control (52) is formed by a wireless communication interface, for example an infrared or radio signal interface (88).

36. The expansion device according to claim 35, wherein the wireless communication interface is formed by a wireless LAN, Bluetooth, GSM or UMTS interface.

37. The expansion device according to claim 35, wherein the interface (39) is formed by a wireless interface designed as a standard type interface on a mobile computer unit (1) to be allocated or received.

38. The expansion device according to claim 15, wherein the interface (39) is formed by a cable-bound interface, for example by a USB or an IEEE 1394 interface.

39. A mobile electronic computer unit (1) adapted to be held in one hand, particularly of the type of a so-called personal data assistant (PDA) or handheld computer, comprising at least one software-controlled processor unit (3); at least one storage device (4) connected to said processor unit for storing software modules and/or data to be processed by said processor unit; at least one display device (8) for the visually detectable output of information; and at least one input device (10) for at least influencing the operations functions of the computer unit (1) and/or for inputting data, whereby the display and input devices (8; 10) are at least in part realized in the form of a screen sensitive to touch, for example in the form of a touch screen (12); and, furthermore, with at least one interface (6; 7) formed on the computer unit (1) as a standard feature, said interface being provided for connecting peripheral electronic or electric device such as, for example a personal computer, wherein a safety switch element (13) of the type of an emergency OFF switch (14) or a quick-stop key or a reliably functioning tripping key and/or an approval key (15).

40. The mobile computer unit according to claim 39, wherein the safety switch element (13) is connected to an input (20, 21) of the processor unit (3) via at least one line (18, 19).

41. The mobile computer unit according to claim 39, wherein the safety switch element (13) is connected to one of the standard-type interfaces (6; 7), or to an interface on the housing (2) of the mobile computer unit (1) specially provided for safety purposes.

42. The mobile computer unit according to claim 39, wherein the safety switch element (13) is arranged in one of the edge zones (23 to 26) of the plate- or panel-like housing (2).

43. The mobile computer unit according to claim 39, wherein the direction of actuation (27) of the safety switch element (13) is aligned parallel to the upper or lower flat side of the housing (2).

44. The mobile computer unit according to claim 39, wherein the emergency OFF switch (14) is arranged in the edge zone (23) of the housing (2) disposed at the top or in front when the housing is in use.

45. The mobile computer unit according to claim 39, wherein an actuation element (22) of the emergency OFF switch (14) protrudes in the form of a mushroom versus the surface of the housing (2).

46. The mobile computer unit according to claim 39, wherein an approval key (15) for executing functions critical to safety is formed in each of the marginal or edge zones (24, 26) on the longitudinal sides of the housing (2).

47. The mobile computer unit according to claim 39, wherein the approval keys (15) are accommodated in breakthroughs (28, 29) of the housing (2), said breakthroughs being covered by an elastically yielding, for example rubber-like membrane (30, 31) for delimiting the interior of the housing (2) versus the environment of the mobile computer (1) in an at least dust-proof manner.

48. The mobile computer unit according to claim 39, wherein the elastically yielding membrane (30, 31) is formed in the longitudinal edge zones of the housing (2), or within reach of the finger tips of the hand of a user holding the mobile computer unit (1).

49. The mobile computer unit according to claim 39, wherein the safety switch element (13) is a multi-stage element comprising both an approval and an emergency OFF function.

50. The mobile computer unit according to claim 49, wherein the safety switch element (13) comprises a no-actuation idle position, an approval position and an emergency OFF or panic position.

51. The mobile computer unit according to claim 50, wherein in the emergency OFF or panic position, an actuation element (16) of an approval key (15) is fixed or defined by exceeding a limit value of the force acting on such actuation element.

52. A manual terminal (77) for monitoring and/or operating and/or programming technical process routines or conditions, comprising at least one software-controlled processor unit (3); at least one storage device (4) linked with said processor unit for storing software modules and/or data to be processed; at least one display device (8) for displaying visually detectable information; and at least one input device (10) for at least influencing the operational functions of the manual terminal (77) and/or for inputting data, whereby the display device and the input device (8; 10) preferably realized in the form of a display screen sensitive to touch, for example of a touch screen (12), structurally superimpose each other or are functionally combined, and comprise at least one interface (6; 7; 39) for linking said devices to a communication interface (56) of the external machine control (52), wherein the display and/or input capabilities of the manual terminal (77) are realized by the touch screen (12) of a standard-type mobile computer unit (1) particularly of the type of a personal data assistant (PDA) or handheld computer.

53. The handheld terminal according to claim 52, wherein at least one manually activated safety switch element (13) of the type of an emergency OFF switch (14) or a quick-stop key or a reliably functioning tripping key and/or an approval key (15) is provided on the housing (78) or support body (33) of said terminal for executing, initiating, terminating or monitoring in a secured manner functions or routines of industrial machine controls (52) and/or of a machine or plant controlled with such a terminal, such functions or routines being critical to safety.

54. The manual terminal according to claim 52, wherein interfaces (6; 7) of a mobile computer unit (1) available on the latter as standard features, are utilized for linking the manual terminal (77) with an external industrial machine control (52) as required.

55. The manual terminal according to claim 52, wherein a standard-type wireless interface (6) of a mobile computer unit (1) is utilized for producing a wireless link with an external industrial machine control (52) within a locally defined data transmission path (89, 90).

56. The manual terminal according to claim 52, wherein at least one transmitting and/or receiving aerial (95, 96) is provided in the housing (78) or on the support body (33) of the manual terminal (77) for enhancing or raising the transmitting and/or receiving power of an allocated standard-type computer unit (1).

57. A supplemental device (62) for an industrial machine control (52) comprising at least a first communication interface (63) for linking it in terms of signal or data transmission technology to a corresponding communication interface (56) of the machine control (52), and at least one additional communication interface (64; 65; 66) for producing a signal or data transmission link to a mobile computer unit (1) as required, or to an expansion device (32) or to a mobile computer unit (1) or to a manual terminal (77).

58. The supplemental device according to claim 57, wherein the first communication interface (63) is formed by a cable-bound and contact-equipped interface, for example by an Interbus-, Profibus-, CAN-, DeviceNet-, Ethernet-, RS232-, USB-, Firewire- or other standard interface leading to a corresponding standard-type communication interface (56) available on an industrial machine control (52).

59. The supplemental device according to claim 57, wherein the additional communication interface (64) is formed by a radio interface (67), for example according to the Bluetooth or Wireless-LAN or GSM or UMTS standards, or according to some other standard-type transmission system for radio signals, such radio signal interface (67) communicating with a radio signal interface (88) provided on a mobile standard-type computer unit (1).

60. The supplemental device according to claim 57, wherein said supplemental device can be structurally combined with an industrial machine control (52) in the way of an expansion module such as, for example an IO-module or plug in card.

61. A wireless communication system (61) for monitoring and/or operating and/or programming the routines or functions of industrial machine controls (52), wherein said communication system is comprised of a mobile computer unit (1), an expansion device (32), a manual terminal (77), and a supplemental device (62).
